(19) United States
(12) Patent Application Publication
(10) Pub. No.: US 2024/0163920 A1
(43) Pub. Date: May 16, 2024

(54) METHOD AND APPARATUS FOR SIDELINK TRANSMISSION IN A WIRELESS COMMUNICATION SYSTEM

(71) Applicant: ASUS Technology Licensing Inc., Taipei City (TW)

(72) Inventors: Chun-Wei Huang, Taipei City (TW); Ming-Che Li, Taipei City (TW)

(21) Appl. No.: 18/382,397

(22) Filed: Oct. 20, 2023

Related U.S. Application Data
(60) Provisional application No. 63/417,737, filed on Oct. 20, 2022.

(51) Int. Cl. H04W 74/0808; H04L 5/00

(52) U.S. Cl. CPC H04W 74/0808; H04L 5/0051

(57) ABSTRACT

Methods, systems, and apparatuses are provided for sidelink transmission in a wireless communication system. In various embodiments, with this and other concepts, systems, and methods of the present invention, a method for a first User Equipment (UE) comprises receiving configuration for configuring two starting symbols in a Transmission Time Interval (TTI) in a sidelink resource pool, wherein a second starting symbol of the two starting symbols is later than a first starting symbol of the two starting symbols, transmitting a signaling to a second UE, wherein the signaling comprises or indicates information of a first specific (symbol) location of Sidelink (SL) Channel State Information Reference Signal (CSI-RS), and performing sidelink transmission with SL CSI-RS in the TTI to the second UE.

### CROSS-REFERENCE TO RELATED APPLICATIONS

The present Application claims priority to and the benefit of U.S. Provisional Patent Application Ser. No. 63/417,737, filed Oct. 20, 2022, which is fully incorporated herein by reference.

### FIELD

This disclosure generally relates to wireless communication networks and, more particularly, to a method and apparatus for sidelink transmission in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for sidelink transmission in a wireless communication system. In various embodiments, with this and other concepts, systems, and methods of the present invention, a method for a first User Equipment (UE) comprises receiving configuration for configuring two starting symbols in a Transmission Time Interval (TTI) in a sidelink resource pool, wherein a second starting symbol of the two starting symbols is later than a first starting symbol of the two starting symbols, transmitting a signaling to a second UE, wherein the signaling comprises or indicates information of a first specific (symbol) location of Sidelink (SL) Channel State Information Reference Signal (CSI-RS), and performing sidelink transmission with SL CSI-RS in the TTI to the second UE.

In various embodiments, with this and other concepts, systems, and methods of the present invention, a method for a first UE comprises receiving configuration for configuring two starting symbols in a TTI in a sidelink resource pool, wherein a second starting symbol of the two starting symbols is later than a first starting symbol of the two starting symbols, transmitting a signaling to a second UE, wherein the signaling comprises or indicates information of a first specific (symbol) location of SL CSI-RS, wherein the first specific (symbol) location is only allowed to be configured with being later than the second starting symbol with an offset, and performing sidelink transmission with SL CSI-RS in the TTI to the second UE.

In various embodiments, with this and other concepts, systems, and methods of the present invention, a method for a first UE comprises receiving configuration for configuring two starting symbols in a TTI in a sidelink resource pool, wherein a second starting symbol of the two starting symbols is later than a first starting symbol of the two starting symbols, transmitting a signaling to a second UE, wherein the signaling comprises or indicates information of a first specific (symbol) location of SL CSI-RS, and triggering a CSI request with a sidelink transmission in the TTI only when the first specific (symbol) location of SL-CSI-RS is after a starting symbol of the sidelink transmission with an offset.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is an example diagram where sl-CSI-RS-FirstSymbol=3, but the TX UE merely pass LBT for symbol index #y, which is latter than #3, in accordance with embodiments of the present invention.

FIG. 6 is an example diagram where slot structure in the bottom may or may not be allowed to comprise starting symbol #y (e.g., there is no additional LBT-passed starting symbol earlier than symbol #y in such slot), in accordance with embodiments of the present invention.

FIG. 7 is an example diagram with the second starting position in symbol #4, when the TX UE configures the first specific location of SL CSI-RS as symbol #5, in accordance with embodiments of the present invention.

FIG. 8 is a flow diagram of a first UE transmitting a signaling to a second UE, wherein the signaling comprises or indicates a first specific location of SL CSI-RS and performing sidelink transmission with SL CSI-RS to the second UE, in accordance with embodiments of the present invention.

FIG. 9 is a flow diagram of a second UE receiving a signaling from a first UE, wherein the signaling comprises or indicates a first specific location of SL CSI-RS and receiving sidelink transmission with SL CSI-RS from the first UE, in accordance with embodiments of the present invention.

FIG. 10 is a flow diagram of a first UE receiving configuration for configuring two starting symbols in a TTI in a sidelink resource pool, transmitting a signaling to a second UE, and performing sidelink transmission with SL CSI-RS in the TTI to the second UE, in accordance with embodiments of the present invention.

FIG. 11 is a flow diagram of a first UE receiving configuration for configuring two starting symbols in a TTI in a sidelink resource pool, transmitting a signaling to a second UE which the signaling indicates location of SL CSI-RS being later than later starting symbol of the two starting symbols with an offset, and performing sidelink transmission with SL CSI-RS in the TTI to the second UE, in accordance with embodiments of the present invention.

FIG. 12 is a flow diagram of a first UE receiving configuration for configuring two starting symbols in a TTI in a sidelink resource pool, transmitting a signaling to a second UE, and triggering a CSI request with a sidelink transmission in the TTI only when the first specific (symbol) location of SL-CSI-RS is after a starting symbol of the sidelink transmission with an offset, in accordance with embodiments of the present invention

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP specification 38.321 v16.7.0; [2] 3GPP TS 37.213 V16.6.0 (2021-06) 3rd Generation Partnership Project; Technical Specification Group Radio Access Network; Physical layer procedures for shared spectrum channel access (Release 16); [3] 5G New Radio Unlicensed: Challenges and Evaluation, Mohammed Hirzallah, Marwan Krunz, Balkan Kecicioglu and Belal Hamzeh-https://arxiv.org/pdf/2012.10937.pdf); [4] 3GPP TS 38.211 V17.3.0 (2022-09) 3rd Generation Partnership Project; Technical Specification Group Radio Access Network; NR; Physical channels and modulation (Release 17); [5] 3GPP TS 38.214 V17.3.0 (2022-09) 3rd Generation Partnership Project; Technical Specification Group Radio Access Network; NR; Physical layer procedures for data (Release 17); [6] 3GPP TS 38.212 V17.1.0 (2022-03) 3rd Generation Partnership Project; Technical Specification Group Radio Access Network; NR; Multiplexing and channel coding (Release 17); [7] 3GPP TS 38.331 V17.0.0 (2022-03) 3rd Generation Partnership Project; Technical Specification Group Radio Access Network; NR; Radio Resource Control (RRC) protocol specification (Release 17); and [8] RP-213678. The standards and documents listed above are hereby expressly and fully incorporated herein by reference in their entirety.

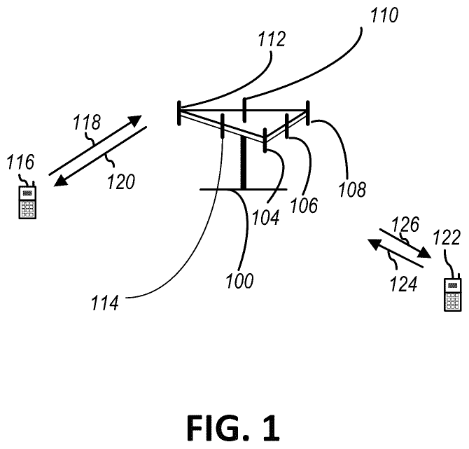

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

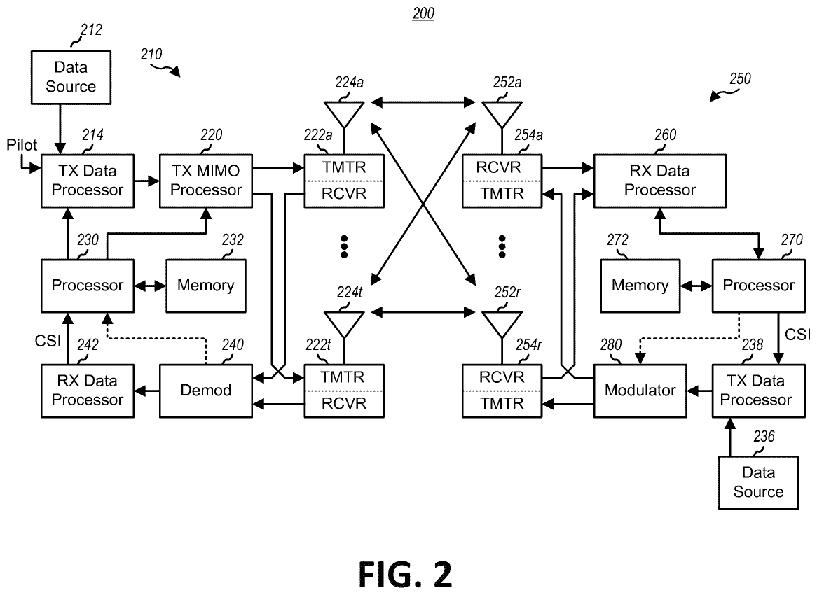

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

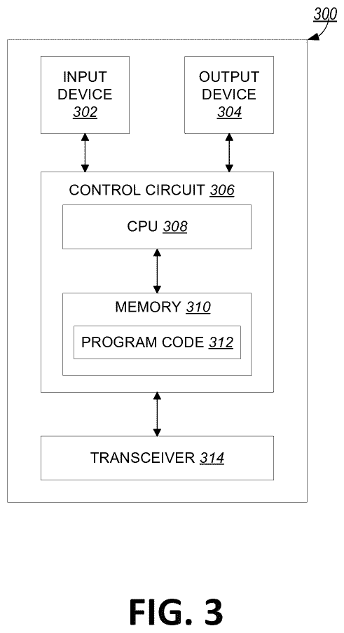

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

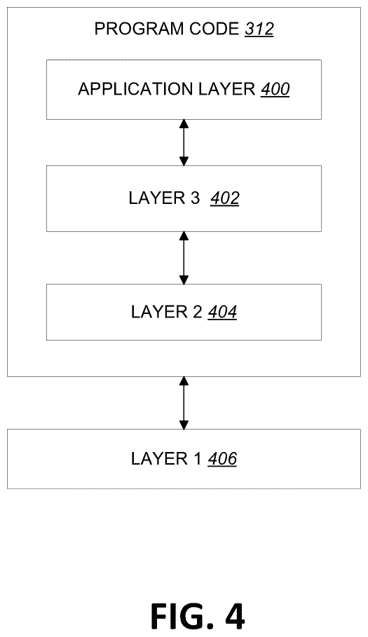

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In [1] 3GPP specification 38.321 v16.7.0, LBT related operation and SL operation is quoted below:

5.21 LBT operation

### 5.21.1 General

The lower layer may perform an LBT procedure, see TS 37.213 [18], according to which a transmission is not performed by lower layers if the channel is identified as being occupied. When lower layer performs an LBT procedure before a transmission and the transmission is not performed, an LBT failure indication is sent to the MAC entity from lower layers.
2>cancel all the triggered consistent LBT failure(s) in this Serving Cell . . . .
   5.22 SL-SCH Data transfer
   5.22.1 SL-SCH Data transmission
   5.22.1.1 SL Grant reception and SCI transmission

Sidelink grant is received dynamically on the PDCCH, configured semi-persistently by RRC or autonomously selected by the MAC entity. The MAC entity shall have a sidelink grant on an active SL BWP to determine a set of PSCCH duration(s) in which transmission of SCI occurs and a set of PSSCH duration(s) in which transmission of SL-SCH associated with the SCI occurs.

If the MAC entity has been configured with Sidelink resource allocation mode 2 to transmit using pool(s) of resources in

a carrier as indicated in TS 38.331 [5] or TS 36.331 based on full sensing, or partial sensing, or random selection or any combination(s), the MAC entity shall for each Sidelink process:
1>if the MAC entity has selected to create a selected sidelink grant corresponding to transmission(s) of a single MAC PDU, and if SL data is available in a logical channel, or an SL-CSI reporting is triggered:
   3>else:
      4>select any pool of resources among the configured pools of resources.
2>else if SL data is available in the logical channel:
   3>if sl-HARQ-FeedbackEnabled is set to enabled for the logical channel:
      4>select any pool of resources configured with PSFCH resources among the pools of resources except the pool(s) in sl-BWP-DiscPoolConfig or sl-BWP-DiscPoolConfigCommon, if configured.
   3>else:
      4>select any pool of resources among the pools of resources except the pool(s) in sl-BWP-DiscPoolConfig or sl-BWP-DiscPoolConfigCommon, if configured.
2>else if an SL-CSI reporting is triggered:
   3>select any pool of resources among the pools of resources except the pool(s) in sl-BWP-DiscPoolConfig or sl-BWP-DiscPoolConfig Common, if configured.
2>perform the TX resource (re-)selection check on the selected pool of resources as specified in clause 5.22.1.2;
   5.22.1.3 Sidelink HARQ operation

### 5.22.1.3.1 Sidelink HARQ Entity

The MAC entity includes at most one Sidelink HARQ entity for transmission on SL-SCH, which maintains a number of parallel Sidelink processes.

The maximum number of transmitting Sidelink processes associated with the Sidelink HARQ Entity is 16. A sidelink process may be configured for transmissions of multiple MAC PDUs. For transmissions of multiple MAC PDUs with Sidelink resource allocation mode 2, the maximum number of transmitting Sidelink processes associated with the Sidelink HARQ Entity is 4.

A delivered sidelink grant and its associated Sidelink transmission information are associated with a Sidelink process. Each Sidelink process supports one TB.

For each sidelink grant, the Sidelink HARQ Entity shall:
1>if the MAC entity determines that the sidelink grant is used for initial transmission as specified in clause 5.22.1.1; or
1>if the sidelink grant is a configured sidelink grant and no MAC PDU has been obtained in an sl-PeriodCG of the configured sidelink grant; or
1>if the sidelink grant is a dynamic sidelink grant or selected sidelink grant and no MAC PDU has been obtained in the previous sidelink grant when PSCCH duration(s) and 2^{nd} stage SCI on PSSCH of the previous sidelink grant is not in SL DRX Active time as specified in clause 5.28.1 of the destination that has data to be sent:
N . . .
   2>(re-)associate a Sidelink process to this grant, and for the associated Sidelink process:
   2>if all PSCCH duration(s) and PSSCH duration(s) for initial transmission of a MAC PDU of the dynamic sidelink grant or the configured sidelink grant is not in SL DRX Active time as specified in clause 5.28.1 of the destination that has data to be sent:
      3>ignore the sidelink grant.
      3>obtain the MAC PDU to transmit from the Multiplexing and assembly entity, if any;
      3>if a MAC PDU to transmit has been obtained:
         4>if a HARQ Process ID has been set for the sidelink grant:
         5>(re-)associate the HARQ Process ID corresponding to the sidelink grant to the Sidelink process.
         4>determines Sidelink transmission information of the TB for the source and destination pair of the MAC PDU as follows:
         5>set the Source Layer-1 ID to the 8 LSB of the Source Layer-2 ID of the MAC PDU;
         5>set the Destination Layer-1 ID to the 16 LSB of the Destination Layer-2 ID of the MAC PDU;
         5>(re-)associate the Sidelink process to a Sidelink process ID;
         5>set the cast type indicator to one of broadcast, groupcast and unicast as indicated by upper layers;
         5>if HARQ feedback has been enabled for the MAC PDU according to clause 5.22.1.4.2;
         6>set the HARQ feedback enabled/disabled indicator to enabled.
         5>else:
         6>set the HARQ feedback enabled/disabled indicator to disabled.
         5>set the priority to the value of the highest priority of the logical channel(s), if any, and a MAC CE, if included, in the MAC PDU;
         7>determine . . .
         5>set the Redundancy version to the selected value.
         4>deliver the MAC PDU, the sidelink grant and the Sidelink transmission information of the TB to the associated Sidelink process;
         4>instruct the associated Sidelink process to trigger a new transmission.
      3>else:
         4>flush the HARQ buffer of the associated Sidelink process.
      3>ignore the sidelink grant . . .
   2>else:
      3>identify the Sidelink process associated with this grant, and for the associated Sidelink process:
         4>deliver the sidelink grant of the MAC PDU to the associated Sidelink process;
         4>instruct the associated Sidelink process to trigger a retransmission.
            5.22.1.3.1a Sidelink process

The Sidelink process is associated with a HARQ buffer.

New transmissions and retransmissions are performed on the resource indicated in the sidelink grant as specified in clause 5.22.1.1 and with the MCS selected as specified in clause 8.1.3.1 of TS 38.214 [7] and clause 5.22.1.1.

If the Sidelink process is configured to perform transmissions of multiple MAC PDUs with Sidelink resource allocation mode 2, the process maintains a counter SL_RESOURCE_RESELECTION_COUNTER. For other configurations of the Sidelink process, this counter is not available.

Priority of a MAC PDU is determined by the highest priority of the logical channel(s) or a MAC CE in the MAC PDU.

### 5.22.1.7 CSI Reporting

The Sidelink Channel State Information (SL-CSI) reporting procedure is used to provide a peer UE with sidelink channel state information as specified in clause 8.5 of TS 38.214 [7].

RRC configures the following parameters to control the SL-CSI reporting procedure:
sl-LatencyBoundCSI-Report, which is maintained for each PC5-RRC connection.

The MAC entity maintains an sl-CSI-ReportTimer for each pair of the Source Layer-2 ID and the Destination Layer-2 ID corresponding to a PC5-RRC connection. sl-CSI-ReportTimer is used for an SL-CSI reporting UE to follow the latency requirement signalled from a CSI triggering UE. The value of sl-CSI-ReportTimer is the same as the latency requirement of the SL-CSI reporting in sl-LatencyBoundCSI-Report configured by RRC.

The MAC entity shall for each pair of the Source Layer-2 ID and the Destination Layer-2 ID corresponding to a PC5-RRC connection which has been established by upper layers:
1>if the SL-CSI reporting has been triggered by an SCI and not cancelled:
   2>if the sl-CSI-ReportTimer for the triggered SL-CSI reporting is not running:
      3>start the sl-CSI-ReportTimer.
   2>if the sl-CSI-ReportTimer for the triggered SL-CSI reporting expires:
      3>cancel the triggered SL-CSI reporting.
   2>else if the MAC entity has SL resources allocated for new transmission and the SL-SCH resources can accommodate the SL-CSI reporting MAC CE and its subheader as a result of logical channel prioritization:
      3>instruct the Multiplexing and Assembly procedure to generate a Sidelink CSI Reporting MAC CE as defined in clause 6.1.3.35;
      3>stop the sl-CSI-ReportTimer for the triggered SL-CSI reporting;
      3>cancel the triggered SL-CSI reporting.

In [2] 3GPP TS 37.213 V16.6.0 (2021-06) (3rd Generation Partnership Project; Technical Specification Group Radio Access Network; Physical layer procedures for shared spectrum channel access (Release 16)), channel procedure for unlicensed spectrum are quoted below.

4 Channel access procedure

### 4.0 General

Unless otherwise noted, the definitions below are applicable for the following terminologies used in this specification:
A channel refers to a carrier or a part of a carrier consisting of a contiguous set of resource blocks (RBs) on which a channel access procedure is performed in shared spectrum.
A channel access procedure is a procedure based on sensing that evaluates the availability of a channel for performing transmissions. The basic unit for sensing is a sensing slot with a duration Tₛₗ=9 us. The sensing slot duration Tₛₗ is considered to be idle if an eNB/gNB or a UE senses the channel during the sensing slot duration, and determines that the detected power for at least 4 us within the sensing slot duration is less than energy detection threshold X_{Thresh}. Otherwise, the sensing slot duration Tₛₗ is considered to be busy.
A channel occupancy refers to transmission(s) on channel(s) by eNB/gNB/UE(s) after performing the corresponding channel access procedures in this clause.
A Channel Occupancy Time refers to the total time for which eNB/gNB/UE and any eNB/gNB/UE(s) sharing the channel occupancy perform transmission(s) on a channel after an eNB/gNB/UE performs the corresponding channel access procedures described in this clause. For determining a Channel Occupancy Time, if a transmission gap is less than or equal to 25 us, the gap duration is counted in the channel occupancy time. A channel occupancy time can be shared for transmission between an eNB/gNB and the corresponding UE(s).
   4.2 Uplink channel access procedures

A UE performing transmission(s) on LAA Scell(s), an eNB scheduling or configuring UL transmission(s) for a UE performing transmission(s) on LAA Scell(s), and a UE performing transmission(s) on channel(s) and a gNB scheduling or configuring UL transmission(s) for a UE performing transmissions on channel(s) shall perform the procedures described in this clause for the UE to access the channel(s) on which the transmission(s) are performed.

In this clause, transmissions from a UE are considered as separate UL transmissions, irrespective of having a gap between transmissions or not, and X_{Thresh} for sensing is adjusted as described in clause 4.2.3 when applicable.

4.2.1 Channel access procedures for uplink transmission(s)

A UE can access a channel on which UL transmission(s) are performed according to one of Type 1 or Type 2 UL channel access procedures. Type 1 channel access procedure is described in clause 4.2.1.1. Type 2 channel access procedure is described in clause 4.2.1.2.

TABLE 4.2.1-1
Channel Access Priority Class (CAPC) for UL

| Channel | | | | | |
|---|---|---|---|---|---|
| Access | | | | | |
| Priority | | | | | |
| Class (p) | mₚ | CW_{min, p} | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, |
| | | | | | 255, 511, 1023} |
| 4 | 7 | 15 | 1023 | 6 ms or 10 ms | {15, 31, 63, 127, |
| | | | | | 255, 511, 1023} |

NOTE1:
For p = 3,4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 us. The maximum duration before including any such gap shall be 6 ms.

4.2.1.1 Type 1 UL channel access procedure

This clause describes channel access procedures by a UE where the time duration spanned by the sensing slots that are sensed to be idle before a UL transmission(s) is random. The clause is applicable to the following transmissions:
PUSCH/SRS transmission(s) scheduled or configured by eNB/gNB, or
PUCCH transmission(s) scheduled or configured by gNB, or
Transmission(s) related to random access procedure.

A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2.
5) sense the channel until either a busy slot is detected within an additional defer duration T_{d} or all the slots of the additional defer duration T_{d} are detected to be idle;
6) if the channel is sensed to be idle during all the slot durations of the additional defer duration Td, go to step 4; else, go to step 5;

The defer duration T_{d} consists of duration T_{f}=16 us immediately followed by mₚ consecutive slot durations where each slot duration is Tₛₗ=9 us, and T_{f} includes an idle slot duration Tₛₗ at start of T_{f}.

4.2.1.2 Type 2 UL channel access procedure

This clause describes channel access procedures by UE where the time duration spanned by the sensing slots that are sensed to be idle before a UL transmission(s) is deterministic.

If a UE is indicated by an eNB to perform Type 2 UL channel access procedures, the UE follows the procedures described in clause 4.2.1.2.1.

4.2.1.2.1 Type 2A UL channel access procedure

If a UE is indicated to perform Type 2A UL channel access procedures, the UE uses Type 2A UL channel access procedures for a UL transmission. The UE may transmit the transmission immediately after sensing the channel to be idle for at least a sensing interval T_{short_ul}=25 us. T_{short_ul} consists of a duration T_{f}=16 us immediately followed by one slot sensing slot and T_{f} includes a sensing slot at start of T_{f}. The channel is considered to be idle for T_{short_ul} if both sensing slots of T_{short_ul} are sensed to be idle.

4.2.1.2.2 Type 2B UL channel access procedure

If a UE is indicated to perform Type 2B UL channel access procedures, the UE uses Type 2B UL channel access procedure for a UL transmission. The UE may transmit the transmission immediately after sensing the channel to be idle within a duration of T_{f}=16 us. T_{f} includes a sensing slot that occurs within the last 9 us of T_{f}. The channel is considered to be idle within the duration T_{f} if the channel is sensed to be idle for total of at least 5 us with at least 4 us of sensing occurring in the sensing slot.

4.2.1.2.3 Type 2C UL channel access procedure

If a UE is indicated to perform Type 2C UL channel access procedures for a UL transmission, the UE does not sense the channel before the transmission. The duration of the corresponding UL transmission is at most 584 us.

In [3] 5G New Radio Unlicensed: Challenges and Evaluation, Mohammed Hirzallah, Marwan Krunz, Balkan Kecicioglu and Belal Hamzeh, brief description for different kind or type LBT or channel access procedure are referenced in the following:

LTE-LAA-/NR-U-based Systems: To facilitate 5G NR-U (also LTE-LAA) operation over unlicensed bands, four LBT Categories (CATs) have been defined:
CAT1-LBT (Type 2C channel access procedure): A network node or UE can access the channel immediately without performing LBT. The COT can be up to 584 microseconds.
CAT2-LBT (Type 2A and 2B channel access procedure): A network node or UE must sense the channel for a fixed time duration, Tfixed. If the channel remains idle during this period, the device can access the channel In Type 2A, Tfixed is 25 microseconds, while in Type 2B, it is 16 microseconds.
CAT3-LBT: An NR-U device must back off for a random period of time before accessing the channel. This random period is sampled from a fixed-size contention window. The option of CAT3-LBT has been excluded from the specifications.
CAT4-LBT (Type 1 channel access procedure): A network node or UE must back off according to the CSMA/CA procedure with exponential backoff

In [4] 3GPP TS 38.211 V17.3.0 (2022-09) 3rd Generation Partnership Project; Technical Specification Group Radio Access Network; NR; Physical channels and modulation (Release 17), Uu CSI-RS and SL CSI-RS related procedure is quoted below:

7.4.1.5.3 Mapping to physical resources

For each CSI-RS configured, the UE shall assume the sequence r(m) being mapped to resources elements (k,l)_{p,μ}according to

$${a}_{k , l}^{( p , μ )} = {β}_{CSIRS} {w}_{f} ( {k}^{′} ) \cdot {w}_{t} ( {l}^{′} ) \cdot {r}_{l , {n}_{s , f}} ( {m}^{′} )$$

$${m}^{′} = ⌊ n α ⌋ + {k}^{′} + ⌊ \frac{\overline{k} ρ}{{N}_{s c}^{RB}} ⌋$$

$$k = n {N}_{sc}^{R B} + \overline{k} + {k}^{′}$$

$$l = \overline{l} + {l}^{′}$$

$$α = \{ \begin{matrix}ρ & for X = 1 \\ 2 ρ & for X > 1\end{matrix}$$

$$n = 0 , 1 , …$$

when the following conditions are fulfilled:
the resource element (k, l)_{p,μ}is within the resource blocks occupied by the CSI-RS resource for which the UE is configured

The reference point for k=0 is subcarrier 0 in common resource block 0.

The time-domain locations l₀∈{0,1, . . . , 13} and l₁∈{2, 3, . . . , 12} are provided by the higher-layer parameters firstOFDMSymbolInTimeDomain and firstOFDMSymbolInTimeDomain2, respectively, in the CSI-RS-ResourceMapping IE or the CSI-RS-ResourceConfigMobility IE and defined relative to the start of a slot.

The UE shall assume that a CSI-RS is transmitted using antenna ports p numbered according to

p=3000+s+jL;

j=0,1, . . . , N/L−1

s=0,1, . . . , L−1;

where s is the sequence index provided by Tables 7.4.1.5.3-2 to 7.4.1.5.3-5, L∈{1,2,4,8} is the CDM group size, and

N is the number of CSI-RS ports. The CDM group index j given in Table 7.4.1.5.3-1 corresponds to the time/frequency locations (k̅,l̅) for a given row of the table.

The UE may assume that antenna ports within a CSI-RS resource are quasi co-located with QCL Type A, Type D (when applicable), and average gain . . .

TABLE 7.4.1.5.3-1
CSI-RS locations within a slot.

| | Ports | Density | | | CDM group | | |
|---|---|---|---|---|---|---|---|
| Row | X | ρ | cdm-Type | (k̅, l̅) | index j | k′ | l′ |
| 1 | 1 | 3 | noCDM | (k₀, l₀), (k₀ + 4, l₀), (k₀ + 8, l₀) | 0, 0, 0 | 0 | 0 |
| 2 | 1 | 1, 0.5 | noCDM | (k₀, l₀), | 0 | 0 | 0 |

8.4.1.5.3 Mapping to physical resources

Mapping to resource elements shall be done according to clause 7.4.1.5.3 with the following exceptions:
only 1 and 2 antenna ports are supported, X∈{1,2};
only density ρ=1 is supported;
the quantity . . .

In [5] 3GPP TS 38.214 V17.3.0 (2022-09) 3rd Generation Partnership Project; Technical

Specification Group Radio Access Network; NR; Physical layer procedures for data (Release 17), SL related procedure is quoted below:

8.1 UE procedure for transmitting the physical sidelink shared channel

Each PSSCH transmission is associated with an PSCCH transmission.

That PSCCH transmission carries the 1^{st} stage of the SCI associated with the PSSCH transmission; the 2^{nd} stage of the associated SCI is carried within the resource of the PSSCH.

A UE is not expected to receive an SCI indicating . . .

8.1.4 UE procedure for determining the subset of resources to be reported to higher layers in PSSCH resource selection in sidelink resource allocation mode 2

In resource allocation mode 2, the higher layer can request the UE to determine a subset of resources from which the higher layer will select resources for PSSCH/PSCCH transmission. To trigger this procedure, in slot n, the higher layer provides the following parameters for this PSSCH/PSCCH transmission:
the resource pool from which the resources are to be reported;
L1 priority, prio_{TX};
the remaining packet delay budget;
the number of sub-channels to be used for the PSSCH/PSCCH transmission in a slot, L_{subCH};
optionally, the resource reservation interval, P_{rsvp_TX}, in units of msec.
Optionally,. . .

The following higher layer parameters affect this procedure:
sl-SelectionWindowList: internal parameter T₂ₘᵢₙ is set to the corresponding value from higher layer parameter sl-SelectionWindowList for the given value of prio_{TX}.
sl-Thres-RSRP-List: this higher layer parameter provides an RSRP threshold for each combination (pᵢ, pⱼ), where pᵢ is the value of the priority field in a received SCI format 1-A and pⱼ is the priority of the transmission of the UE selecting resources; for a given invocation of this procedure, pⱼ=prio_{TX}.
sl-RS-ForSensing selects if the UE uses the PSSCH-RSRP or PSCCH-RSRP measurement, as defined in clause 8.4.2.1.
sl-ResourceReservePeriodList
sl-Sensing Window: internal parameter T₀ is defined as the number of slots corresponding to sl-Sensing Window msec
sl-TxPercentageList: internal parameter X for a given prio_{TX} is defined as sl-TxPercentageList (prio_{TX}) converted from percentage to ratio
Optionally, . . .

The resource reservation interval, P_{rsvp_TX}, if provided, is converted from units of msec to units of logical slots, resulting in P′_{rsvp_TX} according to clause 8.1.7.

When the resource pool is (pre-)configured with sl-AllowedResourceSelectionConfig including full sensing, and full sensing is configured in the UE by higher layers, the UE performs full sensing.

Notation:

(t′₀^{SL}, t′₁^{SL}, t′₂^{SL}) denotes the set of slots which belongs to the sidelink resource pool and is defined in Clause 8.

The following steps are used:
1) A candidate single-slot resource for transmission R_{x,y} is defined as a set of L_{subCH} contiguous sub-channels with sub channel x+j in slot t′_{y}^{SL} where j=0, . . . , L_{subCH}−1. The UE shall assume that any set of L_{subCH} contiguous sub-channels included in the corresponding resource pool within the time interval [n+T₁, n+T₂] correspond to one candidate single-slot resource for UE performing full sensing, in a set of Y candidate slots within the time interval [n+T₁, n+T₂ ] for UE performing periodic-based partial sensing correspond to one candidate single-slot resource, where
selection of T₁ is up to UE implementation under 0≤T₁≤T_{proc,1}^{SL}, where T_{proc,1}^{SL} is defined in slots in Table 8.1.4-2 where μ_{SL} is the SCS configuration of the SL BWP;
if T₂ₘᵢₙ is shorter than the remaining packet delay budget (in slots) then T₂ is up to UE implementation subject to T₂ₘᵢₙ≤T₂≤remaining packet delay budget (in slots); otherwise T₂ is set to the remaining packet delay budget (in slots).
Y is selected by UE where Y≤Yₘᵢₙ.

The total number of candidate single-slot resources is denoted by Mₜₒₜₐₗ.
2) The sensing window is defined by the range of slots [n−T₀, n−T_{proc,0}^{SL}), when the UE performs full sensing, where T₀ is defined above and T_{proc,0}^{SL} is defined in slots in Table 8.1.4-1 where μ_{SL} is the SCS configuration of the SL BWP. The UE shall monitor slots which belongs to a sidelink resource pool within the sensing window except for those in which its own transmissions occur. The UE shall perform the behavior in the following steps based on PSCCH decoded and RSRP measured in these slots.
3) The internal parameter Th(pᵢ,pⱼ) is set to the corresponding value of RSRP threshold indicated by the i-th field in sl-Thres-RSRP-List, where i=pᵢ+(pⱼ−1)*8.
4) The set S_{A} is initialized to the set of all the candidate single-slot resources.
5) The UE shall exclude any candidate single-slot resource R_{x,y} from the set S_{A} if it meets all the following conditions:
the UE has not monitored slot t′ₘ^{SL} in Step 2.
for any periodicity value allowed by the higher layer parameter sl-ResourceReservePeriodList and a hypothetical SCI format 1-A received in slot t′ₘ^{SL} with ‘Resource reservation period’ field set to that periodicity value and indicating all subchannels of the resource pool in this slot, condition c in step 6 would be met.
5a) If the number of candidate single-slot resources R_{x,y} remaining in the set S_{A} is smaller than X·Mₜₒₜₐₗ, the set S_{A} is initialized to the set of all the candidate single-slot resources as in step 4.
6) The UE shall exclude any candidate single-slot resource R_{x,y} from the set S_{A} if it meets all the following conditions:
   a) the UE receives an SCI format 1-A in slot t′ₘ^{SL}, and ‘Resource reservation period’ field, if present, and ‘Priority’ field in the received SCI format 1-A indicate the values P_{rsvp_RX} and prio_{RX}, respectively according to Clause 16.4 in [6, TS 38.213];
   b) the RSRP measurement performed, according to clause 8.4.2.1 for the received SCI format 1-A, is higher than Th(prio_{RX}, prio_{TX});
c) the SCI format received in slot t′ₘ^{SL} or the same SCI format which, if and only if the ‘Resource reservation period’ field is present in the received SCI format 1-A, is assumed to be received in slot(s) t′_{m+q×p′}_{_{rsvp, TX}}^{SL} determines according to clause 8.1.5 the set of resource blocks and slots which overlaps with R_{x,y+j×P′}_{_{rsvp, TX}} for q=1, 2, . . . , Q and j=0, 1, . . . , Cᵣₑₛₑₗ−1. Here, P′_{rsvp_RX} is P_{rsvp_RX} converted to units of logical slots according to clause 8.1.7,

$$Q = ⌈ \frac{{T}_{scal}}{{P}_{rsvp \_ RX}} ⌉$$

if P_{rsvp_RX}<T_{scal} and n′−m≤P′_{rsvp_RX}, where if the UE is configured with full sensing by its higher layer, t′_{n′}^{SL} =n if slot n belongs to the set (t′₀^{SL}, t′₁^{SL}, . . . , t′_{T′}_{ₘₐₓ}₋₁^{SL}), otherwise slot t′_{n′}^{SL} is the first slot after slot n belonging to the set (t′₀^{SL}, t₁^{SL}, . . . , t′_{T′}_{ₘₐₓ}₋₁; . . . If the UE is configured with full sensing by its higher layer, T_{scal} is set to selection window size T₂ converted to units of msec, . . .
6b) This step is executed only if the procedure in clause . . .
7) If the number of candidate single-slot resources remaining in the set S_{A} is smaller than X·Mₜₒₜₐₗ, then Th(pᵢ,pⱼ) is increased by 3 dB for each priority value Th(pᵢ,pⱼ) and the procedure continues with step 4.

The UE shall report set S_{A} to higher layers.

TABLE 8.1.4-1
T_{proc, 0}^{SL} depending on sub-carrier spacing

| | T_{proc, 0}^{SL} |
|---|---|
| μ_{SL} | [slots] |
| 0 | 1 |
| 1 | 1 |
| 2 | 2 |
| 3 | 4 |

TABLE 8.1.4-2
T_{proc, 1}^{SL}depending on sub-carrier spacing

| | T_{proc, 1}^{SL} |
|---|---|
| μ_{SL} | [slots] |
| 0 | 3 |
| 1 | 5 |
| 2 | 9 |
| 3 | 17 |

8.2 UE procedure for transmitting sidelink reference signals
8.2.1 CSI-RS transmission procedure

A UE transmits sidelink CSI-RS within a unicast PSSCH transmission if the following conditions hold:
CSI reporting is enabled by higher layer parameter sl-CSI-Acquisition; and
the ‘CSI request’ field in the corresponding SCI format 2-A is set to 1.

The following parameters for CSI-RS transmission are configured for each CSI-RS configuration:
sl-CSI-RS-FirstSymbol indicates the first OFDM symbol in a PRB used for SL CSI-RS
sl-CSI-RS-FreqAllocation indicates the number of antenna ports and the frequency domain allocation for SL CSI-RS.
   8.5 UE procedure for reporting channel state information (CSI)
   8.5.1 Channel state information framework

CSI consists of Channel Quality Indicator (CQI) and Rank Indicator (RI). The CQI and RI are always reported together.

8.5.1.1 Reporting configurations

The UE shall calculate CSI parameters (if reported) assuming the following dependencies between CSI parameters (if reported)
CQI shall be calculated conditioned on the reported RI

The CSI reporting can be aperiodic (using [10, TS 38.321]). Table 8.5.1.1-1 shows the supported combinations of CSI reporting configurations and CSI-RS configurations and how the CSI reporting is triggered for CSI-RS configuration. Aperiodic CSI-RS is configured and triggered/activated as described in Clause 8.5.1.2.

TABLE 8.5.1.1-1
Triggering/Activation of CSI reporting
for the possible CSI-RS Configurations.

| CSI-RS Configuration | Aperiodic CSI Reporting |
|---|---|
| Aperiodic CSI-RS | Triggered by SCI. |

8.5.1.2 Triggering of sidelink CSI reports

The CSI-triggering UE is not allowed to trigger another aperiodic CSI report for the same UE before the last slot of the expected reception or completion of the ongoing aperiodic CSI report associated with the SCI format 2-A with the ‘CSI request’ field set to 1, where the last slot of the expected reception of the ongoing aperiodic CSI report is given by [10, TS38.321].

An aperiodic CSI report is triggered by an SCI format 2-A with the ‘CSI request’ field set to 1.

A UE is not expected to transmit a sidelink CSI-RS and a sidelink PT-RS which overlap.
cqi-Table=‘table3’ if Table 5.1.3.1-3 is determined as the MCS table according to Clause 8.1.3.1 of [6, 38.214]
   8.5.2.2 Reference signal (CSI-RS)

The UE can be configured with one CSI-RS pattern as indicated by the higher layer parameters sl-CSI-RS-FreqAllocation, sl-CSI-RS-FirstSymbol in SL-CSI-RS-Config.

Parameters for which the UE shall assume non-zero transmission power for CSI-RS are configured according to clause 8.2.1.

A UE is not expected to be configured such that a CSI-RS and the corresponding PSCCH can be mapped to the same resource element. A UE is not expected to receive sidelink CSI-RS and PSSCH DM-RS, nor CSI-RS and 2nd-stage SCI, on the same symbol.

Sidelink CSI-RS shall be transmitted according to [4, TS 38.211] in the resource blocks used for the PSSCH associated with the SCI format 2-A triggering a report.

In [6] 3GPP TS 38.212 V17.1.0 (2022-03) 3rd Generation Partnership Project; Technical Specification Group Radio Access Network; NR; Multiplexing and channel coding (Release 17), Sidelink Control Information is delivered by two stage SCI (e.g., SCI format 1-A and SCI format 2-A which are quoted below):

8.3.1.1 SCI format 1-A

SCI format 1-A is used for the scheduling of PSSCH and 2^{nd}-stage-SCI on PSSCH

The following information is transmitted by means of the SCI format 1-A:
Priority—3 bits as specified in clause 5.4.3.3 of [12, TS 23.287] and clause 5.22.1.3.1 of [8, TS 38.321]. Value ‘000’ of Priority field corresponds to priority value ‘1’, value ‘001’ of Priority field corresponds to priority value 2′, and so on.

$$Frequency resource assignment ⌈ {log}_{2} ( \frac{{N}_{subChannel}^{S L} ( {N}_{subChannel}^{S L} + 1 )}{2} ) ⌉$$

bits when the value of the higher layer parameter sl-MaxNumPerReserve is configured to 2; otherwise

$$⌈ {log}_{2} ( \frac{{N}_{subChannel}^{S L} ( {N}_{subChannel}^{S L} + 1 ) ( 2 {N}_{subChannel}^{SL} + 1}{6} ) ⌉$$

bits when the value of the higher layer parameter sl-MaxNumPerReserve is configured to 3, as defined in clause 8.1.5 of [6, TS 38.214].
Time resource assignment—5 bits when the value of the higher layer parameter sl-MaxNumPerReserve is configured to 2; otherwise 9 bits when the value of the higher layer parameter sl-MaxNumPerReserve is configured to 3, as defined in clause 8.1.5 of [6, TS 38.214].
2nd-stage SCI format—2 bits as defined in Table 8.3.1.1-1.
PSFCH overhead indication—1 bit as defined clause 8.1.3.2 of [6, TS 38.214] if higher layer parameter . . .

TABLE 8.3.1.1-1
2^{nd}-stage SCI formats

| Value of 2nd-stage | |
|---|---|
| SCI format field | 2nd-stage SCI format |
| 00 | SCI format 2-A |
| 01 | SCI format 2-B |
| 10 | SCI format 2-C |
| 11 | Reserved |

8.4.1.1 SCI format 2-A

SCI format 2-A is used for the decoding of PSSCH, with HARQ operation when HARQ-ACK information includes ACK or NACK, when HARQ-ACK information includes only NACK, or when there is no feedback of HARQ-ACK information.

The following information is transmitted by means of the SCI format 2-A:
Source ID—8 bits as defined in clause 8.1 of [6, TS 38.214].
Destination ID—16 bits as defined in clause 8.1 of [6, TS 38.214].
Cast type indicator—2 bits as defined in Table 8.4.1.1-1 and in clause 8.1 of [6, TS 38.214].
CSI request—1 bit as defined in clause 8.2.1 of [6, TS 38.214] and in clause 8.1 of [6, TS 38.214].

In [7] 3GPP TS 38.331 V17.0.0 (2022-03) 3rd Generation Partnership Project; Technical Specification Group Radio Access Network; NR; Radio Resource Control (RRC) protocol specification (Release 17), some IEs are quoted below:
SL-BWP-Con fig

The IE SL-BWP-Config is used to configure the UE specific NR sidelink communication on one particular sidelink bandwidth part.

### SL-BWP-Config Information Element

-- ASN1START
-- TAG-SL-BWP-CONFIG-START

| | |
|---|---|
| SL-BWP-Config-r16 ::= | SEQUENCE { |
| sl-BWP-Id | BWP-Id, |
| sl-BWP-Generic-r16 | SL-BWP-Generic-r16 |

| | |
|---|---|
| OPTIONAL, | -- Need M |

| | |
|---|---|
| sl-BWP-PoolConfig-r16 | SL-BWP-PoolConfig-r16 |

| | |
|---|---|
| OPTIONAL, | -- Need M |

..., ]]
}

| | |
|---|---|
| SL-BWP-Generic-r16 ::= | SEQUENCE { |
| sl-BWP-r16 | BWP |

| | |
|---|---|
| OPTIONAL, | -- Need M |

| | |
|---|---|
| sl-LengthSymbols-r16 | ENUMERATED {sym7, sym8, sym9, sym10, sym11, sym12, |

| | |
|---|---|
| sym13, sym14} | OPTIONAL, -- Need M |

| | |
|---|---|
| sl-StartSymbol-r16 | ENUMERATED {sym0, sym1, sym2, sym3, sym4, sym5, sym6, |

| | |
|---|---|
| sym7} | OPTIONAL, -- Need M |

}
-- TAG-SL-BWP-CONFIG-STOP
-- ASN1STOP

SL-BWP-Config field descriptions

. . .
sl-BWP-Generic
This field indicates the generic parameters on the configured sidelink BWP.
sl-BWP-PoolConfig
This field indicates the resource pool configurations on the configured sidelink BWP.
sl-BWP-Id
An identifier for this sidelink bandwidth part.

SL-BWP-Generic field descriptions

sl-LengthSymbols
This field indicates the number of symbols used for sidelink in a slot without SL-SSB. A single value can be
(pre)configured per sidelink bandwidth part.
sl-StartSymbol
This field indicates the starting symbol used for sidelink in a slot without SL-SSB. A single value can be (pre)configured
per sidelink bandwidth part.

SL-BWP-PoolConfig

The IE SL-BWP-PoolConfig is used to configure NR sidelink communication resource pool.

### SL-BWP-PoolConfig Information Element

ASN1START
-- TAG-SL-BWP-POOLCONFIG-START

| | |
|---|---|
| SL-BWP-PoolConfig-r16 ::= | SEQUENCE { |
| sl-RxPool-r16 | SEQUENCE (SIZE (1..maxNrofRXPool-r16)) OF SL-ResourcePool-r16 |

OPTIONAL, -- Cond HO

| | |
|---|---|
| sl-TxPoolSelectedNormal-r16 | SL-TxPoolDedicated-r16 |

OPTIONAL, -- Need M
...
}

| | |
|---|---|
| SL-TxPoolDedicated-r16 | SEQUENCE { |
| sl-PoolToReleaseList-r16 | SEQUENCE (SIZE (1..maxNrofTXPool-r16)) OF SL-ResourcePoolID-r16 |

OPTIONAL, -- Need N

| | |
|---|---|
| sl-PoolToAddModList-r16 | SEQUENCE (SIZE (1..maxNrofTXPool-r16)) OF SL-ResourcePoolConfig- |

r16 OPTIONAL -- Need N
}

| | |
|---|---|
| SL-ResourcePoolConfig-r16 :: = | SEQUENCE { |
| sl-ResourcePoolID-r16 | SL-ResourcePoolID-r16, |
| sl-ResourcePool-r16 | SL-ResourcePool-r16 |

OPTIONAL -- Need M
}

| | |
|---|---|
| SL-ResourcePoolID-r16 ::= | INTEGER (1..maxNrofPoolID-r16) |

-- TAG-SL-BWP-POOLCONFIG-STOP
-- ASN1STOP

SL-BWP-PoolConfig field descriptions

sl-RxPool
Indicates the receiving resource pool on the configured BWP. For the PSFCH related configuration, if configured, will be
used for PSFCH transmission/reception. If the field is included, it replaces any previous list, i.e. all the entries of the list
are replaced and each of the SL-ResourcePool entries is considered to be newly created.
Indicates the resources by which the UE is allowed to transmit . . .
sl-TxPoolSelectedNormal
Indicates the resources by which the UE is allowed to transmit NR sidelink communication by UE autonomous resource
selection on the configured BWP. For the PSFCH related configuration, if configured, will be used for PSFCH
transmission/reception.

SL-FreqConfig

The IE SL-FreqConfig specifies the dedicated configuration information on one particular carrier frequency for NR sidelink communication.

### SL-FreqConfig Information Element

-- ASN1START
- TAG-SL-FREQCONFIG-START

| | |
|---|---|
| SL-FreqConfig-r16 ::= | SEQUENCE { |
| sl-Freq-Id-r16 | SL-Freq-Id-r16, |
| sl-SCS-SpecificCarrierList-r16 | SEQUENCE (SIZE (1..maxSCSs)) OF SCS-SpecificCarrier, |
| sl-AbsoluteFrequencyPointA-r16 | ARFCN-ValueNR |

OPTIONAL, -- Need M

| | |
|---|---|
| valueN-r16 | ... |
| sl-BWP-ToReleaseList-r16 | SEQUENCE (SIZE (1..maxNrofSL-BWPs-r16)) OF BWP-Id |

OPTIONAL, -- Need N

| | |
|---|---|
| sl-BWP-ToAddModList-r16 | SEQUENCE (SIZE (1..maxNrofSL-BWPs-r16)) OF SL-BWP-Config-r16 |

OPTIONAL, -- Need N

| | |
|---|---|
| sl-SyncPriority-r16 | ... |

}

| | |
|---|---|
| SL-Freq-Id-r16 ::= | INTEGER (1.. maxNrofFreqSL-r16) |

-- TAG-SL-FREQCONFIG-STOP
-- ASN1STOP

SL-ConfigDedicatedNR

The IE SL-ConfigDedicatedNR specifies the dedicated configuration information for NR sidelink communication.

### SL-ConfigDedicatedNR Information Element

-- ASN1START
-- TAG-SL-CONFIGDEDICATEDNR-START

| | |
|---|---|
| SL-ConfigDedicatedNR-r16 ::= | SEQUENCE { |
| sl-PHY-MAC-RLC-Config-r16 | SL-PHY-MAC-RLC-Config-r16 |

OPTIONAL, -- Need M

| | |
|---|---|
| sl-RadioBearerToAddModList-r16 | ... |
| sl-MeasConfigInfoToReleaseList-r16 | SEQUENCE (SIZE (1..maxNrofSL-Dest-r16)) OF SL- |

| | |
|---|---|
| DestinationIndex-r16 | OPTIONAL, -- Need N |

| | |
|---|---|
| sl-MeasConfigInfoToAddModList-r16 | SEQUENCE (SIZE (1..maxNrofSL-Dest-r16)) OF SL- |

| | |
|---|---|
| MeasConfigInfo-r16 | OPTIONAL, -- Need N |

```
    ...,
  [[
```

| | |
|---|---|
| sl-PHY-MAC-RLC-Config-v1700 | SL-PHY-MAC-RLC-Config-v1700 |

OPTIONAL, -- Need M

| | |
|---|---|
| sl-RLC-ChannelToAddModList-r17 | ... |

]]
}

| | |
|---|---|
| SL-DestinationIndex-r16 ::= | INTEGER (0..maxNrofSL-Dest-1-r16) |
| SL-PHY-MAC-RLC-Config-r16::= | SEQUENCE { |
| sl-ScheduledConfig-r16 | SetupRelease { SL-ScheduledConfig-r16 } |

OPTIONAL, -- Need M

| | |
|---|---|
| sl-UE-SelectedConfig-r16 | SetupRelease { SL-UE-SelectedConfig-r16 } |

OPTIONAL, -- Need M

| | |
|---|---|
| sl-FreqInfoToReleaseList-r16 | SEQUENCE (SIZE (1..maxNrofFreqSL-r16)) OF SL-Freq-Id-r16 |

OPTIONAL, -- Need N

| | |
|---|---|
| sl-FreqInfoToAddModList-r16 | SEQUENCE (SIZE (1..maxNrofFreqSL-r16)) OF SL-FreqConfig-r16 |

OPTIONAL, -- Need N

| | |
|---|---|
| sl-MaxNumConsecutiveDTX-r16 | ... |
| sl-CSI-Acquisition-r16 | ENUMERATED {enabled} |

OPTIONAL, -- Need R

| | |
|---|---|
| sl-CSI-SchedulingRequestId-r16 | SetupRelease {SchedulingRequestId} |

OPTIONAL, -- Need M
...
}

| | |
|---|---|
| sl-RemoteUE-Config-r17 | SetupRelease { SL-RemoteUE-Config-r17} |

...
}
-- TAG-SL-CONFIGDEDICATEDNR-STOP
-- ASN1STOP
...

SL-PHY-MAC-RLC-Config field descriptions

. . .
sl-CSI-Acquisition
Indicates whether CSI reporting is enabled in sidelink unicast. If the field is absent, sidelink CSI reporting is disabled.
sl-CSI-SchedulingRequestId
If present, it indicates the scheduling request configuration applicable for sidelink CSI report MAC CE, as specified in
TS 38.321 [3].

SL-ResourcePool

The IE SL-ResourcePool specifies the configuration information for NR sidelink communication resource pool.

### SL-ResourcePool Information Element

-- ASN1START
-- TAG-SL-RESOURCEPOOL-START

| | |
|---|---|
| SL-ResourcePool-r16 ::= | SEQUENCE { |
| sl-SyncAllowed-r16 | SL-SyncAllowed-r16 |

...

| | |
|---|---|
| sl-SubchannelSize-r16 | ENUMERATED {n10, n12, n15, n20, n25, n50, n75, n100} |

OPTIONAL, -- Need M
...

| | |
|---|---|
| sl-StartRB-Subchannel-r16 | INTEGER (0..265) |

OPTIONAL, -- Need M

| | |
|---|---|
| sl-NumSubchannel-r16 | INTEGER (1..27) |

OPTIONAL, -- Need M

| | |
|---|---|
| sl-ThreshS-RSSI-CBR-r16 | ... |
| sl-TimeWindowSizeCBR-r16 | ENUMERATED {ms100, slot100} |

OPTIONAL, Need M

| | |
|---|---|
| sl-TimeWindowSizeCR-r16 | ENUMERATED {ms1000, slot1000} |

OPTIONAL, -- Need M
...

| | |
|---|---|
| sl-UE-SelectedConfigRP-r16 | SL-UE-SelectedConfigRP-r16 |

OPTIONAL, -- Need M

| | |
|---|---|
| sl-FilterCoefficient-r16 | FilterCoefficient |

...

| | |
|---|---|
| sl-RB-Number-r16 | INTEGER (10..275) |

OPTIONAL, -- Need M

| | |
|---|---|
| sl-PowerControl-r16 | SL-PowerControl-r16 |

...

| | |
|---|---|
| sl-TimeResource-r16 | BIT STRING (SIZE (10..160)) |

OPTIONAL -- Need M
]]...
}

| | |
|---|---|
| SL-PSCCH-Config-r16 ::= | SEQUENCE { |
| sl-TimeResourcePSCCH-r16 | ENUMERATED {n2, n3} |

OPTIONAL, -- Need M

| | |
|---|---|
| sl-FreqResourcePSCCH-r16 | ENUMERATED {n10, n12, n15, n20, n25} |

OPTIONAL, -- Need M
...
}
}...

| | |
|---|---|
| SL-ResourceReservePeriod-r16 ::= | CHOICE { |
| sl-ResourceReservePeriod1-r16 | ENUMERATED {ms0, ms100, ms200, ms300, ms400, ms500, ms600, |

ms700, ms800, ms900, ms1000},

| | |
|---|---|
| sl-ResourceReservePeriod2-r16 | INTEGER (1..99) |

}

| | |
|---|---|
| SL-SelectionWindowList-r16 ::= | SEQUENCE (SIZE (8)) OF SL-SelectionWindowConfig-r16 |
| SL-SelectionWindowConfig-r16 ::= | SEQUENCE { |
| sl-Priority-r16 | INTEGER (1..8), |
| sl-SelectionWindow-r16 | ENUMERATED {n1, n5, n10, n20} |

}
......
}
-- TAG-SL-RESOURCEPOOL-STOP
-- ASN1STOP

SL-ResourcePool field descriptions

. . .
sl-NumSubchannel
Indicates the number of subchannels in the corresponding resource pool, which consists of contiguous PRBs only.
sl-RB-Number
Indicates the number of PRBs in the corresponding resource pool, which consists of contiguous PRBs only. The
remaining RB cannot be used (See TS 38.214[19], clause 8).
sl-StartRB-Subchannel
Indicates the lowest RB index of the subchannel with the lowest index in the resource pool with respect to the lowest RB
index of a SL BWP.
sl-SubchannelSize
Indicates the minimum granularity in frequency domain for the sensing for PSSCH resource selection in the unit of PRB.
. . .
sl-TimeResource
Indicates the bitmap of the resource pool, which is defined by repeating the bitmap with a periodicity during a SFN or
DFN cycle.

SL-PSCCH-Config field descriptions

sl-FreqResourcePSCCH
Indicates the number of PRBs for PSCCH in a resource pool where it is not greater than the number PRBs of the
subchannel.
Indicates the initialization value for PSCCH DMRS scrambling . . .
sl-TimeResourcePSCCH
Indicates the number of symbols of PSCCH in a resource pool.

RRCReconfigurationSidelink

The RRCReconfigurationSidelink message is the command to AS configuration of the PC5 RRC connection. It is only applied to unicast of NR sidelink communication.
RLC-SAP: AM . . .
Logical channel: SCCH
Direction: UE to UE

### RRCReconfigurationSidelink Message

-- ASN1START
-- TAG-RRCRECONFIGURATIONSIDELINK-START

| | |
|---|---|
| RRCReconfigurationSidelink ::= | SEQUENCE { |
| rrc-TransactionIdentifier-r16 | RRC-TransactionIdentifier, |
| criticalExtensions | CHOICE { |
| rrcReconfigurationSidelink-r16 | RRCReconfigurationSidelink-IEs-r16, |
| criticalExtensionsFuture | SEQUENCE { } |

}
}

| | |
|---|---|
| RRCReconfigurationSidelink-IEs-r16 ::= | SEQUENCE { |
| sl-CSI-RS-Config-r16 | SetupRelease {SL-CSI-RS-Config-r16} |

OPTIONAL, -- Need M

| | |
|---|---|
| SL-CSI-RS-Config-r16 ::= | SEQUENCE { |
| sl-CSI-RS-FreqAllocation-r16 | CHOICE { |
| sl-OneAntennaPort-r16 | BIT STRING (SIZE (12)), |
| sl-TwoAntennaPort-r16 | BIT STRING (SIZE (6)) |

}
OPTIONAL, -- Need M

| | |
|---|---|
| sl-CSI-RS-FirstSymbol-r16 | INTEGER (3..12) |

OPTIONAL, -- Need M
...
}

In [8] RP-213678, justification and objective for performing SL transmission on unlicensed spectrum are quoted below:

### Justification

Although NR sidelink was initially developed for V2X applications, there is growing interest in the industry to expand the applicability of NR sidelink to commercial use cases. For commercial sidelink applications, two key requirements have been identified:
Increased sidelink data rate
Support of new carrier frequencies for sidelink

Increased sidelink data rate is motivated by applications such as sensor information (video) sharing between vehicles with high degree of driving automation. Commercial use cases could require data rates in excess of what is possible in Rel-17. Increased data rate can be achieved with the support of sidelink carrier aggregation and sidelink over unlicensed spectrum.

### 4 Objective

4.1 Objective of SI or Core part WI or Testing part WI

Study and specify support of sidelink on unlicensed spectrum for both mode 1 and mode 2 where Uu operation for mode 1 is limited to licensed spectrum only [RAN1, RAN2, RAN4]
Channel access mechanisms from NR-U shall be reused for sidelink unlicensed operation
   Assess the applicability of sidelink resource reservation from Rel-16/Rel-17 to sidelink unlicensed operation within the boundaries of unlicensed channel access mechanism and operation
      If the existing NR-U channel access framework does not support the required SL-U functionality, WGs will make appropriate recommendations for RAN approval . . .
Physical channel design framework: Required changes to NR sidelink physical channel structures and procedures to operate on unlicensed spectrum
   The existing NR sidelink and NR-U channel structure shall be reused as the baseline.

In New Radio (NR) Rel-16, it is a first release for NR sidelink Vehicle-to-Everything (V2X), and current standard has already meet requirement as defined in SA1Considering the upcoming future, with more and more devices requiring higher throughput and higher data rate, sidelink transmission on wider frequency resources may be desired. However, current bands supporting PC5 interface or sidelink transmission may not be enough. Thus, introduction of sidelink transmission on unlicensed/shared spectrum with large spectrum availability may be one targeted solution. In order to have fair coexistence with other devices in the same or different Radio Access Technology (RAT) or different techniques (e.g., WiFi) in unlicensed spectrum, Listen-Before-Talk (LBT) may be required. LBT is one energy detection or sensing technique, according to LBT result (which is idle or busy) before transmission, a device could determine whether the transmission is allowed. There is a short introduction of New Radio-Unlicensed for Uu interface in [2] 3GPP TS 37.213 V16.6.0 (2021-06) and [3] 5G New Radio Unlicensed: Challenges and Evaluation. LBT could briefly separate into short LBT (e.g., CAT1-LBT, and CAT2-LBT) and long LBT (e.g., CAT4-LBT). For short LBT, a device may be allowed to perform transmission without LBT or perform relative short LBT; while for long LBT, a device may need to perform transmission with LBT with a relative longer time (e.g., with more sensing slots being idle and preferably with back off). Long LBT corresponds to type-1 channel access procedure in TS 37.213, and short LBT corresponds to type-2/2A/2B/2C channel access procedure in TS 37.213. While for sidelink reception, continuously monitoring or receiving or detecting sidelink resources may be one assumption in a sidelink device.

In NR Rel-16, for resource allocation mode-1 in NR sidelink V2X (e.g., network scheduling mode), Transmit (TX) User Equipment (UE) may receive one sidelink grant from a network node and the sidelink grant may schedule one, two, or three sidelink resource(s) in a sidelink resource pool. The sidelink grant may indicate one Physical Uplink Control Channel (PUCCH) resource (in response to whether TX UE needs another sidelink resource(s)). The sidelink grant indicates the one PUCCH resource by at least indicating a slot offset with respect to slot of a Physical Sidelink Feedback Channel (PSFCH) time location (e.g., indicating PUCCH is in which slot). The sidelink grant indicates the one PUCCH resource by at least PUCCH resource indicator (e.g., within the slot, indicating which PUCCH resource). The PUCCH resource indicator would indicate one PUCCH resource in each set of PUCCH resources in the slot. The slot of the PUCCH resource is based on the slot offset and slot of a PSFCH, wherein the PSFCH is associated with the last scheduled sidelink resource(s). Size of Hybrid Automatic Repeat Request (HARQ) information associated with sidelink may impact on the UE determining which set of PUCCH resources in the slot is being used. The one PUCCH resource is later than the last PSFCH time location associated with last scheduled resources among the one, two, or three scheduled sidelink resource(s). In addition, HARQ information associated with sidelink may associate with one sub-codebook and HARQ information associated with downlink assignment may associate with another sub-codebook. HARQ information associated with downlink assignment could be HARQ information in response to PDSCH (including Semi-Persistent Scheduling (SPS) Physical Data Shared Channel (PDSCH)), SPS release (i.e., Physical Downlink Control Channel (PDCCH) only indicating SPS release), beam indication Downlink Control Information (DCI) without downlink assignment (i.e., PDCCH only indicating beam indication), dormancy without downlink assignment (i.e., PDCCH only indicating dormancy). PUCCH carrying/delivering the one sub-codebook and PUCCH carrying/delivering the other/another sub-codebook shall be different PUCCH resources. Different PUCCH resources may be in time domain division. Different PUCCH resources may be two different PUCCHs in different slots or in different symbols. UE does not multiplex the one sub-codebook and the other/another sub-codebook into one PUCCH resource. TX UE performs sidelink transmission via the scheduled sidelink resource(s) to one or more Receiver (RX) UE(s). TX UE may set Sidelink (SL) HARQ enable or not enable (disable) for the sidelink transmission. The one, two, or three scheduled sidelink resource(s) are associated with a same Transport Block (TB)/Medium Access Control (MAC) Protocol Data Unit (PDU) or different TB/MAC PDUs. The one, two, or three scheduled sidelink resource(s) may be in consecutive (physical) slots or in consecutive (sidelink) slots in the sidelink resource pool.

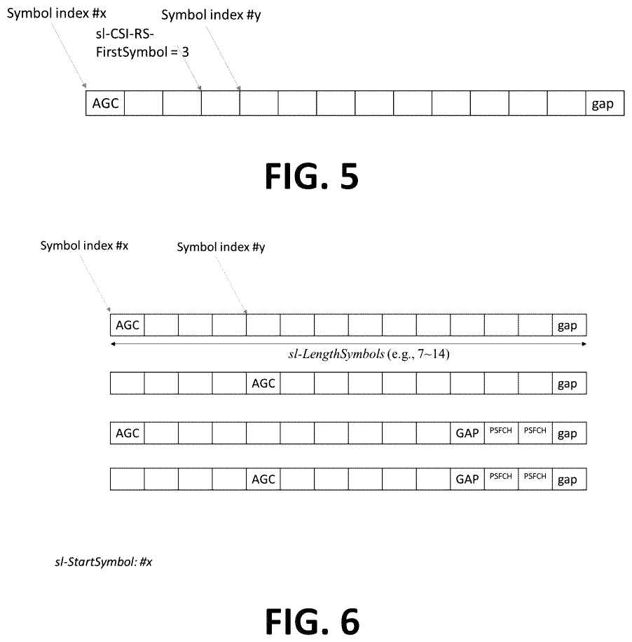

In NR Rel-17, power saving enhancement for sidelink was introduced. For NR rel-18, people are trying to improve throughput of sidelink for supporting higher data rate service. Possible direction is to apply carrier aggregation, apply FR2 carrier which has larger bandwidth, and/or apply sidelink on unlicensed spectrum. One general assumption for sidelink on unlicensed spectrum is PC5 interface (i.e., an interface between UE and UE) is on unlicensed spectrum and Uu interface (i.e., an interface between UE and network node) is on licensed spectrum. With aspect of uncertainty of LBT failure for each channel/signal on unlicensed spectrum, increasing transmission occasions/opportunities are considered. For example, it may be beneficial to increase time opportunities of Physical Sidelink Control Channel (PSCCH)/Physical Sidelink Shared Channel (PSSCH). In the previous release, time domain unit for sidelink transmission is one Transmission Time Interval (TTI)/slot/subframe and there is only one starting symbol position (which may be configured in SL Bandwidth Part (BWP) configuration, e.g., configured via sl-StartSymbol in SL-BWP-Config) in each TTI/slot/subframe. However, with introduction of sidelink using unlicensed spectrum, it may be less competitive for TX UE with only one starting symbol. Once TX UE cannot pass LBT for initiating Channel Occupancy Time (COT) for legacy starting symbol, the TX UE needs to perform LBT for next slot which may cause unnecessary latency (especially when other RAT merely occupy a number of starting symbols in TX UE's LBT failed slot/TTI). More than one (candidate) starting symbols in a sidelink slot could leverage sidelink transmission on unlicensed spectrum. Once TX UE fails to pass LBT for the first (candidate) starting symbol but could pass LBT for the next (candidate) starting symbol, TX UE could still perform sidelink transmission in the slot. One assumption is that the same sidelink resource pool could be (pre-)configured with the one or more (candidate) starting symbols in a slot. An alternative assumption is that the one or more (candidate) starting symbols could be (pre-)configured in a different sidelink resource pool, which the two different sidelink resource pools at least comprise one same slot (preferably in the same or a different sub-channel and/or carrier/SL BWP). No matter which assumption is used, there are at least two (candidate) starting symbol position(s) denoted as #x and #y, wherein #x is earlier than #y (e.g., x is smaller than y), and #x is #0-#13, #y is #0-#13 in one example. However, according to the current standard, there would be some issues for SL Channel State Information Reference Signal (CSI-RS) transmission due to the additional (candidate) starting symbol for PSCCH/PSSCH. In legacy release, the TX UE could indicate one starting symbol for SL CSI-RS, via configuring sl-CSI-RS-FirstSymbol which is 3-12, to the RX UE based on PCS Radio Resource Control (RRC) signal (e.g., SL CSI-RS configuration). But, when performing sidelink transmission on unlicensed spectrum, LBT result may impact that original configured starting symbol for SL CSI-RS (e.g., sl-CSI-RS-FirstSymbol) is not available due to restriction for SL CSI-RS (e.g., SL CSI-RS shall be transmitted with PSCCH/PSSCH, and/or SL CSI-RS shall be transmitted no overlapping with Phase Tracking Reference Signal (PTRS), and/or SL CSI-RS shall be transmitted to different resource elements than PSCCH, and/or SL CSI-RS shall be transmitted to a different symbol than 2nd stage SCI). For example, in FIG. 5, sl-CSI-RS-FirstSymbol =3, but, the TX UE merely pass LBT for symbol index #y which is later than #3. In this example, whether TX UE can perform SL CSI-RS transmission along with PSCCH/PSSCH, which starts from #y, may need a design.

Preferably in certain embodiments, in some examples, slot structure in the bottom one in FIG. 6 may or may not be allowed to comprise starting symbol #y (e.g., there is no additional LBT-passed starting symbol earlier than symbol #y in such slot). Preferably and/or alternatively, (candidate) starting symbol #y in FIG. 6 may be (pre-)configured, taking into account the remaining number of symbols (for PSCCH/PSSCH transmission/reception) being larger than or equal to a threshold (e.g., 5). Preferably in certain embodiments, when (candidate) starting symbol #y in FIG. 6 is (pre-)configured such that the remaining number of symbols (for PSCCH/PSSCH transmission/reception) being larger than or equal to a threshold (e.g., 5), such slot or slot structure with additional starting symbol #y could be used for PSCCH/PSSCH transmission/reception (e.g., such slot is available with additional (candidate) starting symbol for TX UE to transmit and/or available for RX UE to receive, if RX UE does not detect SCI right before the slot). Preferably in certain embodiments, when (candidate) starting symbol #y in FIG. 6 is (pre-)configured such that the remaining number of symbols (for PSSCH transmission/reception) being smaller than a threshold (e.g., 5), such slot or slot structure with additional (candidate) starting symbol #y could be not used for PSCCH/PSSCH transmission/reception. Preferably in certain embodiments, based on the threshold constraint, slot with PSFCH may have or be configured with additional (candidate) starting symbol for PSCCH/PSSCH transmission/reception. Note that the remaining number of symbols for PSCCH/PSSCH transmission/reception in a slot may be derived/determined based on the starting symbol position and the existence/absence of PSFCH resource/occasion.

### Concept 0

Concept 0 is a brief summary of concept 1-concept 3.

1. PC5 RRC configuration restriction for configuring SL-CSI-RS location with an offset later than the 2nd starting symbol (e.g., sl-CSI-RS-FirstSymbol-r16 >#y+3).

2. Assuming PC5 RRC configuration for configuring SL-CSI-RS location keeps the same as legacy candidate value (e.g., 3-12), a triggering restriction is introduced.
TX UE is allowed to trigger CSI request with a sidelink transmission only when SL CSI-RS location is after the starting symbol of the sidelink transmission with an offset.
TX UE is not allowed to trigger CSI request when the TX UE access channel from the 2nd starting symbol and SL-CSI-RS location is before the 2nd starting symbol with an offset.

3. Introducing a second SL-CSI-RS location with an offset later than the 2nd starting symbol (e.g., sl-CSI-RS-FirstSymbol-r16, and sl-CSI-RS-FirstSymbol2-r18).

4. Changing the definition of SL-CSI-RS location in the PC5 RRC configuration.
For the 1st starting symbol, SL-CSI-RS location is referenced to symbol 0 (e.g., sl-CSI-RS-FirstSymbol-r16).
For the 2nd starting symbol, SL-CSI-RS location is referenced to the 2nd starting symbol (e.g., sl-CSI-RS-FirstSymbol-r16+#y<13).

### Concept 1

This concept 1 is to determine the starting (symbol) location of SL CSI-RS for a first (candidate) occasion of PSCCH/PSSCH, or for a second (candidate) occasion of PSCCH/PSSCH in a slot based on the first and second starting (symbol) location (configured) of each/corresponding (candidate) occasion, respectively. Preferably in certain embodiments, if more than two (candidate) starting (symbol) locations in a slot is configured, starting (symbol) location of CSI-RS is determined based on at least the starting (symbol) location of each occasion. Preferably in certain embodiments, the starting (symbol) location of SL CSI-RS in a slot is determined/derived based on the starting (symbol) location used/applied in the slot. Preferably in certain embodiments, for the first (candidate) occasion of PSCCH/PSSCH in a first slot, the starting (symbol) location of SL CSI-RS in the first slot is determined/derived based on the first starting (symbol) location of the first occasion. For the second (candidate) occasion of PSCCH/PSSCH in a second slot, the starting (symbol) location of SL CSI-RS in the second slot is determined/derived based on the second starting (symbol) location of the second occasion. The second starting (symbol) location is with a different symbol index from the first starting (symbol) location. Preferably in certain embodiments, the starting (symbol) location of each (candidate) occasion could be replaced/mean/changed/used by an Automatic Gain Control (AGC) symbol for each (candidate) occasion, and/or the starting (symbol) location of SL CSI-RS could be referenced to the AGC symbol for each (candidate) occasion. Preferably in certain embodiments, the starting (symbol) location of each (candidate) occasion could be replaced/mean/changed/used by the (starting/ending) PSCCH symbol, and/or the starting (symbol) location of SL CSI-RS could be referenced to the (starting/ending) PSCCH symbol for the respective (candidate) occasion of PSCCH/PSSCH. Preferably in certain embodiments, the TX UE would transmit PC5 RRC signaling to the RX UE for configuring a first specific (symbol) location of SL CSI-RS. Preferably in certain embodiments, the first specific (symbol) location is configured by sl-CSI-RS-FirstSymbol. Preferably in certain embodiments, for a slot comprising more than one (candidate) occasions of PSCCH/PSSCH with different (candidate) starting (symbol) locations, one embodiment of concept 1 is to determine more than one (candidate) starting (symbol) locations of SL CSI-RS for the more than one (candidate) occasions of PSCCH/PSSCH based on the first specific location and/or more than one corresponding (candidate) starting (symbol) locations of the more than one (candidate) occasions of PSCCH/PSSCH. In this case, the first specific location may be considered/replaced/mean/changed/used as a first specific (symbol) offset between a starting (symbol) location of SL CSI-RS and a starting (symbol) location of one (candidate) occasion of PSCCH/PSSCH. Preferably in certain embodiments, for a slot comprising (only) one (candidate) occasion of PSCCH/PSSCH with corresponding starting (symbol) location, one starting (symbol) location of SL CSI-RS for the one (candidate) occasion of PSCCH/PSSCH is determined based on the first specific location and/or the corresponding starting (symbol) location of the one (candidate) occasion of PSCCH/PSSCH. Preferably in certain embodiments, the starting (symbol) location of SL CSI-RS (in each of one or more occasion of PSCCH/PSSCH) is determined based on the first specific location and/or the starting (symbol) location of each of the one or more occasion of PSCCH/PSSCH. For example, the first specific location is 3, and the first starting (symbol) location of the first occasion of PSCCH/PSSCH is symbol #0, and the starting (symbol) location of the second occasion of PSCCH/PSSCH is symbol #7. The starting location of SL CSI-RS is transmitted in symbol #3 (which is determined by #0+3) in the first occasion of PSCCH/PSSCH. The starting (symbol) location of SL CSI-RS is transmitted in symbol #10 (which is determined by #7+3). Based on a different starting (symbol) location of occasion of PSCCH/PSSCH or based on a different reference symbol, a different starting (symbol) location for SL CSI-RS (within a slot) could be determined. Preferably in certain embodiments, the first specific location is symbol index (offset) which could be determined or referenced based on the different reference symbol. Preferably in certain embodiments, if there is no configured second starting (symbol) location of occasion of PSCCH/PSSCH, the first specific location is symbol index referenced to symbol #0. Alternatively and/or preferably, no matter the starting symbol/location of occasion of PSCCH/PSSCH, the first specific location is symbol index referenced to symbol #0 for the first occasion of PSCCH/PSSCH. The first specific location is the symbol index (offset) referenced to a symbol other than symbol #0 (and/or referenced to the starting symbol/location of occasion of PSCCH/PSSCH other than the first occasion of PSCCH/PSSCH) for occasion of PSCCH/PSSCH other than the first occasion of PSCCH/PSSCH (the starting symbol/location of the second occasion of PSCCH/PSSCH may be later than the starting symbol/location of the first occasion of PSCCH/PSSCH). For example, the first occasion, second occasion starts from the symbol with index #2, #7, respectively, and the first specific location is 4. Starting (symbol) location of SL CSI-RS for the first occasion of PSCCH/PSSCH is symbol #4 (which is determined by #0+4). Starting (symbol) location of SL CSI-RS for the second occasion of PSCCH/PSSCH is symbol #11 (which is determined by #7+4).

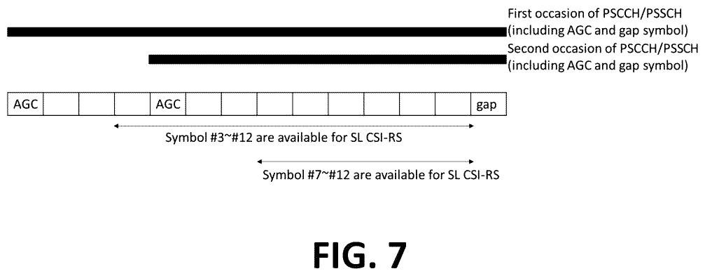

Alternatively and/or preferably, one embodiment of concept 1 is to determine one starting (symbol) location of SL CSI-RS for one or more (candidate) occasions of PSCCH/PSSCH based on the first specific location. The determination may be not based on the (candidate) starting (symbol) location(s) of the one or more (candidate) occasions of PSCCH/PSSCH. Preferably in certain embodiments, the candidate value for the first specific location shall at least be larger than the starting location/symbol of any of the one or more (candidate) occasions of PSCCH/PSSCH. Assuming that for a slot comprising at least first and second (candidate) occasions of PSCCH/PSSCH with corresponding first and second (candidate) starting locations/symbols, the second starting location/symbol of the second occasion of PSCCH/PSSCH is later than the first starting location/symbol of the first occasion of PSCCH/PSSCH. Preferably in certain embodiments, there is a constraint or limitation for the first specific location value that the starting symbol of SL CSI-RS (based on the first specific location value) is later than the second starting location/symbol of the second occasion of PSCCH/PSSCH. Preferably in certain embodiments, there is a constraint or limitation for the first specific location value that the starting symbol of SL CSI-RS (based on the first specific location value) is later than the second starting location/symbol of the second occasion of PSCCH/PSSCH with an offset. Preferably in certain embodiments, the offset corresponds to value 3 or 4. Preferably in certain embodiments, the offset is used for avoiding SL CSI-RS overlapping with PSCCH and AGC (preceding PSCCH) (in symbol domain). Preferably in certain embodiments, (based on this constraint or limitation), the first (candidate) occasion and the second (candidate) occasion could share a same starting (symbol) location of SL CSI-RS. Preferably in certain embodiments, the concept 1 could provide less signaling but ensure to have opportunity to transmit SL CSI-RS in the second (candidate) occasion of PSCCH/PSSCH. For example, the first occasion, the second occasion starts from symbol with index #2, #7, respectively. In this example, the first specific location shall be configured at least later than #7 (i.e., at least to ensure there is opportunity for transmitting SL CSI-RS). Preferably in certain embodiments, the first specific location shall be configured at least later than #10 (i.e., at least to ensure there is opportunity for transmitting SL CSI-RS and also avoiding symbols for AGC and (two-symbol) PSCCH). Preferably in certain embodiments, the first specific location is referenced to symbol #0. Preferably in certain embodiments, the first specific location is symbol index in a slot. Preferably in certain embodiments, the candidate value for the first specific location (in this example) is #10, #11, #12 (which may exclude the last symbol for gap, e.g., symbol #13). Preferably in certain embodiments, assuming the TX UE configures the RX UE with the first specific location (of SL CSI-RS) as #10. Preferably in certain embodiments, no matter if the TX UE transmits PSCCH/PSSCH using first or second (candidate) occasion of PSCCH/PSSCH in a slot (according to LBT/channel access result), once/when/if the TX UE would like to request CSI reporting, the TX UE could transmit SL CSI-RS starting from symbol#10 (along with PSSCH transmission). Preferably in certain embodiments, the TX UE would transmit SL CSI-RS starting from the starting (symbol) location of SL CSI-RS. For example, in FIG. 7, when the TX UE will use the second starting position in a slot (in a sidelink resource pool), available value for the first specific location (of SL CSI-RS) is #7˜#12 in this example assuming there are 14 symbols for sidelink in a slot and the second starting position is in symbol #4 (and two symbols are utilized for PSCCH).

Alternatively and/or preferably, there is some value (e.g., #0˜#6) of the first specific location that the TX UE is not allowed to transmit SL CSI-RS and/or set CSI request as “triggered” and/or trigger the CSI request in SCI within/using the second occasion of PSCCH/PSSCH (when the TX UE transmits PSCCH/PSSCH using the second occasion of PSCCH/PSSCH).

Preferably in certain embodiments, for the first specific location being (configured to be) earlier than the second starting (symbol) position of the second occasion of PSCCH/PSSCH, the TX UE does not and is not allowed to transmit SL CSI-RS or set the CSI request as “triggered” or trigger CSI request in SCI in the second occasion of PSCCH/PSSCH.

Preferably in certain embodiments, for the first specific location being (configured to be) the same as the second starting (symbol) position of the second occasion of PSCCH/PSSCH, the TX UE does not and is not allowed to transmit SL CSI-RS or set CSI request as “triggered” or trigger the CSI request in SCI in the second occasion of PSCCH/PSSCH.

Preferably in certain embodiments, for the first specific location being (configured to be) later than the second starting (symbol) position of the second occasion of PSCCH/PSSCH but overlapping with PSCCH symbol(s), the TX UE does not and is not allowed to transmit SL CSI-RS or set CSI request as “triggered” or trigger the CSI request in SCI in the second occasion of PSCCH/PSSCH.

For example, in FIG. 7 with the second starting position in symbol #4, when the TX UE configures the first specific location of SL CSI-RS as symbol #5, the TX UE is not allowed or does not transmit SL CSI-RS or set CSI request as “triggered” or trigger the CSI request in SCI in the second occasion of PSCCH/PSSCH, since symbols #5-6 are utilized for PSCCH.

Preferably in certain embodiments, based on using the first or the second (candidate) occasion in a slot, the TX UE may determine whether to (be able/allowed to) trigger CSI request and/or transmit SL CSI-RS in the slot. Preferably in certain embodiments, when the TX UE configures the first specific location with some values, the TX UE determines whether to (be able/allowed to) transmit SL CSI-RS based on using the first or the second (candidate) occasion in a slot. Preferably in certain embodiments, once the TX UE passes LBT for transmitting on/using the first occasion in a slot, the TX UE could transmit SL CSI-RS or trigger CSI request in SCI (in the slot). Preferably in certain embodiments, once the TX UE passes LBT for transmitting on/using the second occasion in a slot, the TX UE is not allowed or does not transmit SL CSI-RS or trigger CSI request in SCI (in the slot). Preferably in certain embodiments, this may happen even if the first specific location (of SL CSI-RS) is configured in the symbol earlier than the second starting (symbol) position of the second occasion of PSCCH/PSSCH or overlapping with the PSCCH symbol.

Preferably in certain embodiments, different (candidate) occasions of PSCCH/PSSCH would partially overlap in time domain.

Preferably in certain embodiments, different (candidate) occasions of PSCCH/PSSCH may comprise a same or different ending symbol.

Preferably in certain embodiments, different (candidate) occasions of PSCCH/PSSCH start in different (symbol) locations.

Preferably in certain embodiments, the starting (symbol) location of each (candidate) occasion of PSCCH/PSSCH is AGC symbol or utilized for AGC.

Preferably in certain embodiments, the last (symbol) location of each (candidate) occasion of PSCCH/PSSCH is a gap symbol or utilized for the TX-RX switch.

Preferably in certain embodiments, at least the first (candidate) occasion and the second (candidate) occasion of PSCCH/PSSCH are in a same slot. Either one of at least the first (candidate) occasion and the second (candidate) occasion (of PSCCH/PSSCH) is utilized/applied in the same slot based on a channel access result, LBT result, and/or within or outside a COT.

### Concept 2

This concept 2 is to determine the starting (symbol) location of SL CSI-RS for a first (candidate) occasion of PSCCH/PSSCH, and for a (candidate) second occasion of PSCCH/PSSCH in a slot based on a respective specific location of SL CSI-RS.

Preferably in certain embodiments, the TX UE would transmit PC5 RRC signaling to the RX UE for configuring a first specific location of SL CSI-RS for the first (candidate) occasion of PSCCH/PSSCH. Preferably in certain embodiments, the TX UE would transmit PC5 RRC signaling to the RX UE for configuring a second specific location of SL CSI-RS for the second (candidate) occasion of PSCCH/PSSCH.

Preferably in certain embodiments, the first specific location is associated/utilized with the first (candidate) occasion of PSCCH/PSSCH.

Preferably in certain embodiments, the second specific location is associated/utilized with the second (candidate) occasion of PSCCH/PSSCH.

Preferably in certain embodiments, the first specific location could be the same or different than the second specific location.

Preferably in certain embodiments, at least the first (candidate) occasion and the second (candidate) occasion (of PSCCH/PSSCH) are in a same slot. Either one of at least the first (candidate) occasion and the second (candidate) occasion (of PSCCH/PSSCH) is utilized/applied in the same slot based on a channel access result, LBT result, and/or within or outside a COT.

Preferably in certain embodiments, a second starting location/symbol of the second (candidate) occasion of PSCCH/PSSCH is later than a first starting location/symbol of the first (candidate) occasion of PSCCH/PSSCH. Preferably in certain embodiments, the second specific location is not allowed to be configured earlier/smaller than the first specific location.

Preferably in certain embodiments, the TX UE transmits SL CSI-RS on the first specific location based on the TX UE transmits PSCCH/PSSCH on/using the first occasion of PSCCH/PSSCH.

Preferably in certain embodiments, the TX UE transmits SL CSI-RS on the second specific location based on the TX UE transmits PSCCH/PSSCH on/using the second occasion of PSCCH/PSSCH.

Preferably in certain embodiments, based on a channel access result for the first or the second (candidate) occasion for PSCCH/PSSCH transmission, when the TX UE would transmit SL CSI-RS and/or trigger the CSI request, the TX UE could determine to transmit SL CSI-RS on either the first or the second specific location. Preferably in certain embodiments, possible values for the first specific location could be #3˜#12. Preferably in certain embodiments, possible value for the second specific location could be #3˜#12. Preferably in certain embodiments, restriction may be applied for the possible value of the second specific location, e.g., restriction based on the second starting location/symbol of the second (candidate) occasion, or restriction based on the second starting location/symbol and PSCCH symbol(s) utilized for the second candidate occasion.

Preferably in certain embodiments, example of the first specific location and the second specific location could be illustrated below. Preferably in certain embodiments, a choice structure is to configure whether to have list-based signaling. Preferably in certain embodiments, the list could indicate at least two specific locations of SL CSI-RS (associated with different (candidate) occasions) in/for a slot. Preferably in certain embodiments, the list may be conditioned on at least a slot in a sidelink resource pool/SL BWP/carrier with at least two (candidate) starting (symbol) positions (or with at least two (candidate) occasions of PSCCH/PSSCH in a slot).

| | |
|---|---|
| SL-CSI-RS-Config-r16 ::= | SEQUENCE { |

```
  ...
  Sl-CSI-RS-FirstSymbol-allocation CHOICE {
```

| | |
|---|---|
| sl-CSI-RS-FirstSymbol-r16 | INTEGER (3..12) |

OPTIONAL, -- Need M

| | |
|---|---|
| sl-CSI-RS-FirstSymbollist-r18 | SEQUENCE (SIZE (1..maxNrofstartingposinslot)) OF |
| INTEGER (3..12) | OPTIONAL, -- Need M |

...
}

Preferably in certain embodiments, another example of the first specific location and the second specific location could be illustrated below. Preferably in certain embodiments, sl-CSI-RS-FirstSymbol is used to configure the first specific location (of SL CSI-RS). Preferably in certain embodiments, sl-CSI-RS-FirstSymbol2 is used to configure the second specific location (of SL CSI-RS). Preferably in certain embodiments, sl-CSI-RS-FirstSymbol2 may be optional. Preferably in certain embodiments, sl-CSI-RS-FirstSymbol2 could exist depending on at least whether the slot is configured with two (candidate) starting (symbol) positions (or more than one (candidate) starting (symbol) positions) for PSCCH/PSSCH transmission.

| | |
|---|---|
| SL-CSI-RS-Config-r16 ::= | SEQUENCE { |

```
  ...
  Sl-CSI-RS-FirstSymbol-allocation CHOICE {
```

| | |
|---|---|
| sl-CSI-RS-FirstSymbol-r16 | INTEGER (3..12) |

OPTIONAL, -- Need M

| | |
|---|---|
| sl-CSI-RS-FirstSymbol2 | INTEGER (3..12) |

OPTIONAL, -- Need M and/or preferably conditioned on slot configured
with two starting positions
...
}

Preferably in certain embodiments, once there is no parameter (in PC5 RRC signaling) for configuring the second specific location, the second specific location is the same as the first specific location.

Preferably in certain embodiments, once there is no parameter (in PC5 RRC signaling) for configuring the second specific location, there is no second specific location for transmitting SL CSI-RS.

Preferably in certain embodiments, once there is no parameter (in PC5 RRC signaling) for configuring second specific location, second specific location may depend on whether the first specific location is in the available symbol for transmitting SL CSI-RS in the second (candidate) occasion (e.g., #7˜#12 is available in FIG. 7, while #3˜#6 is not available in FIG. 7). Preferably in certain embodiments, if the first specific location is in the available symbol for transmitting SL CSI-RS in the second (candidate) occasion, the TX UE could (be able/allowed to) transmit SL CSI-RS and/or trigger the CSI request in SCI in the second (candidate) occasion. Preferably in certain embodiments, if the first specific location is not in the available symbol for transmitting SL CSI-RS in the second (candidate) occasion, the TX UE is not allowed or does not transmit SL CSI-RS and/or trigger the CSI request in SCI in the second occasion. Preferably in certain embodiments, the available symbol for transmitting SL CSI-RS in the second (candidate) occasion may mean/comprise that the symbol is later than the second starting location/symbol and/or PSCCH symbol(s) utilized for the second candidate occasion. Preferably in certain embodiments, the non-available symbol for transmitting SL CSI-RS in the second (candidate) occasion may mean/comprise that the symbol is earlier than the second starting location/symbol or overlapping PSCCH symbol(s) utilized for the second candidate occasion.

Preferably in certain embodiments, once there is no parameter (in PC5 RRC signaling) for configuring a second specific location, the second specific location may be determined based on a value of the first specific location and the second starting location/symbol. In other words, the second specific location is the value of the first specific location relative/referenced to the second starting location/symbol.

Preferably and/or alternatively, the no parameter (in PC5 RRC signaling) for configuring the second specific location may comprise/mean that the parameter for configuring second specific location is not set/existed in the PC5 RRC signaling. Preferably and/or alternatively, the no parameter (in PC5 RRC signaling) for configuring the second specific location may comprise/mean that the parameter for configuring the second specific location is set as the same value as the parameter for configuring the first specific location in the PC5 RRC signaling. Preferably and/or alternatively, the no parameter (in PC5 RRC signaling) for configuring the second specific location may comprise/mean that the parameter for configuring the second specific location is set as a value such that the second specific location is earlier than the second starting location/symbol or overlapping PSCCH symbol(s) utilized for the second candidate occasion.

### Concept 3

This concept 3 is to transmit SL CSI-RS merely in the first (candidate) occasion of PSCCH/PSSCH. Preferably in certain embodiments, when a slot is configured with at least two (candidate) starting (symbol) positions (e.g., the first and second (candidate) starting (symbol) position for the respective first and second (candidate) occasion), the TX UE (is able/allowed to) transmits SL CSI-RS in the slot only if the TX UE could transmit PSCCH/PSSCH on/using the first occasion. Preferably in certain embodiments, once the TX UE fails to access the channel for transmitting PSCCH/PSSCH on/using the first occasion but access the channel for transmitting PSCCH/PSSCH on/using the second occasion in same slot, the TX UE is not allowed or does not transmit SL CSI-RS and/or trigger the CSI request on the second (candidate) occasion. Preferably in certain embodiments, no matter if the specific location of SL CSI-RS is configured being later than the second (candidate) starting (symbol) position, the TX UE is not allowed or does not transmit SL CSI-RS and/or trigger the CSI request on the second (candidate) occasion. Preferably in certain embodiments, the TX UE only transmits SL CSI-RS in a slot, wherein the UE could transmit PSCCH/PSSCH on/using the first occasion in the slot.

Preferably in certain embodiments, a second starting location/symbol of the second (candidate) occasion of PSCCH/PSSCH is later than a first starting location/symbol of the first (candidate) occasion of PSCCH/PSSCH. Preferably in certain embodiments, the specific location is associated/utilized with the first (candidate) occasion of PSCCH/PSSCH, not the second (candidate) occasion of PSCCH/PSSCH.

Preferably in certain embodiments, the starting (symbol) position, the starting (symbol) location, and/or the starting location/symbol may be changed/represented/exchanged with each other.

Preferably in certain embodiments, the TX UE will (actually) utilize/apply either one of the at least two starting (symbol) positions in/for a slot in a sidelink resource pool (e.g., based on channel access result, LBT result, and/or within or outside a COT). Preferably in certain embodiments, the TX UE does not (allowed to) utilize/apply more than one starting (symbol) position in/for a slot in a sidelink resource pool.

Preferably in certain embodiments, the first starting (symbol) position may be (pre-)configured based on sl-StartSymbol.

Preferably in certain embodiments, the second starting (symbol) position may be (pre-)configured based on another parameter (different than sl-StartSymbol). Preferably in certain embodiments, the other/another parameter would configure the second starting (symbol) position (directly). Preferably in certain embodiments, the range of the other/another parameter would be #3˜#12 which each # corresponds to a symbol index within a slot. Preferably in certain embodiments, the range of the other/another parameter would be #(first starting (symbol) position+an particular offset)˜#12. Preferably in certain embodiments, the other/another parameter is configured such that the second starting (symbol) position is at least the particular offset later than the first starting (symbol) position. Preferably in certain embodiments, one example could be shown below and preferably with constraint that the first starting (symbol) position (determined from sl-StartSymbol) is earlier than the second starting (symbol) position (determined from sl-StartSymbol2).

| | |
|---|---|
| sl-StartSymbol-r16 | ENUMERATED {sym0, sym1, sym2, sym3, sym4, sym5, sym6, sym7} |

OPTIONAL, -- Need M

| | |
|---|---|
| sl-StartSymbol2-r18 | ENUMERATED {sym0, sym1, sym2, sym3, sym4, sym5, sym6, sym7} |

OPTIONAL, --Need M

Alternatively and/or preferably, the other/another parameter (indirectly) configure/provide the second starting (symbol) position. In other words, the other/another parameter provides/configures an offset. Preferably in certain embodiments, the second starting (symbol) position is determined based on or configured by both sl-StartSymbol and the offset. Preferably in certain embodiments, the second starting (symbol) position is #(first starting (symbol) position+the offset). Preferably in certain embodiments, the offset shall be larger than or equal to a particular offset. Preferably in certain embodiments, rationale of the particular offset is to guarantee fairness between an NR SL-U UE and other UEs. Preferably in certain embodiments, if the #(first starting (symbol) position+the offset) or the second starting (symbol) position is not available in a slot for transmitting PSCCH/PSSCH (e.g., PSFCH symbols, gap for switching to PSFCH, or length/symbols in a slot for transmitting PSSCH starting from the second starting (symbol) position is not enough or smaller than a threshold), the TX UE and/or the RX UE does not or is not allowed to transmit/receive PSSCH starting from the second starting (symbol) position in the slot. Preferably in certain embodiments, whether the second starting (symbol) position is configured or not is based on whether the other/another parameter (e.g., the offset) is configured or not.

Preferably in certain embodiments, one example could be shown below and preferably the second starting (symbol) position is determined from sl-StartSymbol with sl-offset, or sl-StartSymbol with sl-offset-1.

| | |
|---|---|
| sl-StartSymbol-r16 | ENUMERATED {sym0, sym1, sym2, sym3, sym4, sym5, sym6, sym7} |

OPTIONAL, -- Need M

| | |
|---|---|
| sl-offset | ENUMERATED {sym0, sym1, sym2, sym3, sym4, sym5, sym6, sym7} |

OPTIONAL, -- Need M

Alternatively and/or preferably, the first starting (symbol) position and the second starting (symbol) position could be (pre-)configured based on code-point form or list form. One example below could be shown, where an RRC parameter could configure up to maximum number of (candidate) starting (symbol) position within a slot (e.g., maxNrofstartingposinslot, for example is 2). Preferably in certain embodiments, each entry in the list is not allowed to correspond or corresponds to a different value of the starting (symbol) position or different enumerated value associated with the starting (symbol) position.

sl-StartSymbollist-r18 SEQUENCE (SIZE (1..maxNrofstartingposinslot)) OF
ENUMERATED {sym0, sym1, sym2, sym3, sym4, sym5, sym6, sym7} OPTIONAL, -- Need M

For another example, an offset list is used to indicate one or more (candidate) starting (symbol) position(s) within a slot (for PSSCH). Preferably in certain embodiments, the offset list may indicate the starting (symbol) position other than the first starting (symbol) position. Preferably in certain embodiments, based on each offset in the offset list, the TX UE and/or the RX UE could determine the one or more starting (symbol) position(s) within a slot (for PSCCH/PSSCH). Preferably in certain embodiments, each entry in the offset list is associated with one offset value according to the first starting (symbol) position (e.g., based on sl-StartSymbol). Preferably in certain embodiments, one example is shown below, and preferably each symx (e.g., x=0˜13) in sl-offsetlist corresponds to one offset, and preferably the candidate symx (x=0˜13) in sl-offsetlist could be any combination of the following example. Preferably in certain embodiments, symx (x=0˜13) in sl-offsetlist in the following example is not allowed to configure (such as #first starting (symbol) position+symx is larger than the slot boundary, e.g., 13 or 14, or #first starting (symbol) position +symx is larger than sl-LengthSymbols-2). Preferably in certain embodiments, symx (x=0˜13) in sl-offsetlist in the following example is smaller than (or equal to) sl-LengthSymbols-2. Preferably in certain embodiments, symx (x=0˜13) in sl-offsetlist in the following example is also to make sure the second starting (symbol) position does not overlap with a gap and/or PSFCH symbol.

For another example, sl-LengthSymbols is associated with 10, and sl-StartSymbol is associated with symbol #2, and sl-offsetlist with one entry associated with 4.

First occasion (including AGC and gap symbol) is with symbols #2˜#11 occupying 10 symbols.

The second occasion (including AGC and gap symbol) is with symbols #6˜#11 occupying 6 symbols, which the second starting (symbol) position symbol #6 determined based on symbol #(2+4)). Alternatively, (based on different meaning of offset), the second occasion (including AGC and gap symbol) is with symbols #5˜#11 occupying 7 symbols, which the second starting (symbol) position symbol #5 determined based on #(2+4−1)).

| | |
|---|---|
| sl-StartSymbol-r16 | ENUMERATED {sym0, sym1, sym2, sym3, sym4, sym5, sym6, sym7} |

OPTIONAL, -- Need M

| | |
|---|---|
| sl-offsetlist | SEQUENCE (SIZE (1..maxNrofstartingposinslot)) OF ENUMERATED |

{sym0, sym1, sym2, sym3, sym4, sym5, sym6, sym7, sym8, sym9, sym10, sym11, sym12} OPTIONAL,
-- Need M

Preferably in certain embodiments, the limitation or constraint for the second starting (symbol) position may be applied such that it shall be any of the following which assume the 1st starting (symbol) position is symbol #0, #1, #4 for example considering the second occasion shall comprise at least 7 symbols (including AGC and gap symbol). Preferably in certain embodiments, the earliest 2nd starting position is at least a particular offset later than the 1st starting position.

| | | | (Candidate) | |
|---|---|---|---|---|
| | | (Candidate) | 2nd starting | 2nd starting |
| | | 2nd starting | (symbol) position | (symbol) position |
| | | (symbol) position | shall take PSFCH | (based on RRC) and |
| | | Slot without PSFCH | slot into account | whether slot with |
| | | (Note1: #1 could | (Note1: #1 could | PSFCH is not available |
| | | be replaced by | be replaced by | (Note1: #1 could |
| | | particular offset) | particular offset) | be replaced by |
| | | (Note2: the earliest | (Note2: the earliest | particular offset) |
| | | candidate second | candidate second | (Note2: symbol earlier |
| 1st starting | | starting position | starting position | than particular offset |
| (symbol) | Length for | shall be later than | shall be later than | is not available as 2nd |
| position | SL in a slot | particular offset) | particular offset) | starting position) |
| #0 | 14 | #1~#7 | #1~#4 | #1~#4 |
| | | | | available |
| | | | | #5~#7 |
| | | | | not available |
| | 13 | #1~#6 | #1~#3 | #1~#3 |
| | | | | available |
| | | | | #4~#6 |
| | | | | not available |
| | 12 | #1~#5 | #1~#2 | #1~#2 |
| | | | | available |
| | | | | #3~#5 |
| | | | | not available |
| | 11 | #1~#4 | #1 | #1 available |
| | | | | #2~#4 |
| | | | | not available |
| | 10 | #1~#3 | N/A | N/A |
| | 9 | #1~#2 | N/A | N/A |
| | 8 | #1 | N/A | N/A |
| | 7 | N/A | N/A | N/A |
| #1 | 13 | #2~#7 | #2~#4 | #2~#4 |
| | | | | available |
| | | | | #5~#7 |
| | | | | not available |
| | 12 | #2~#6 | #2~#3 | #2~#3 |
| | | | | available |
| | | | | #4~#6 |
| | | | | not available |
| | 11 | #2~#5 | #2 | #2 available |
| | | | | #3~#5 |
| | | | | not available |
| | 10 | #2~#4 | N/A | N/A |
| | 9 | #2~#3 | N/A | N/A |
| | 8 | #2 | N/A | N/A |
| | 7 | N/A | N/A | N/A |
| #4 | 10 | #5~#7 | N/A | N/A |
| | 9 | #5~#6 | N/A | N/A |
| | 8 | #5 | N/A | N/A |
| | 7 | N/A | N/A | N/A |

Preferably in certain embodiments, signaling detail of the other/another parameter is on the same level with the parameter for configuring the first starting (symbol) position (e.g., sl-StartSymbol). Preferably in certain embodiments, the other/another parameter is (pre-)configured in a sidelink resource pool/SL BWP/SL carrier/LBT band (e.g., one RB set for LBT, e.g., 20 MHz for performing LBT).

Preferably in certain embodiments, [symbol] could be 2.

Preferably in certain embodiments, [symbol] could be larger than 2.

Preferably in certain embodiments, considering sidelink traffic payload size and/or

Demodulation Reference Signal (DMRS) pattern design, there may be some constraint or limitation for the second starting position.

Preferably in certain embodiments, SL BWP and/or sidelink resource pool which does not comprise enough length/number of symbols for sidelink transmission in a slot may not be available for (configuring) the second starting (symbol) position. In other words, even in unlicensed spectrum, the second starting (symbol) position may be not (pre-)configured.

Preferably in certain embodiments, when SL BWP and/or sidelink resource pool which does not comprise enough length/number of symbols for sidelink transmission or slot with PSFCH does not comprise enough length/number of symbols, there is no second starting (symbol) position in these slots.

Preferably in certain embodiments, when/if SL BWP and/or sidelink resource pool comprises enough length/number of symbols for sidelink transmission in a slot, there may be some slots which are not available with the second starting (symbol) position. Preferably in certain embodiments, for example, the slot with PSFCH which does not comprise enough length/number of symbols is not available with the second starting (symbol) position.

Preferably in certain embodiments, enough length/number of symbols may refer to Z (e.g., Z=5) symbols (not including AGC and gap symbols).

Preferably in certain embodiments, enough length/number of symbols may refer to sl-LengthSymbols/2 and preferably with floor function or function of round down to integer.

Preferably in certain embodiments, the slot could be replaced by subframe or TTI, or sidelink slot. The slot may mean a sidelink slot in a sidelink resource pool.

Preferably in certain embodiments, PSCCH/PSSCH could be NR PSCCH/PSSCH or LTE PSCCH/PSSCH.

Preferably in certain embodiments, the first starting (symbol) position in a slot comprises/refers to AGC symbol for a first (candidate) occasion for transmitting PSCCH/PSSCH in the slot.

Preferably in certain embodiments, the second starting (symbol) position in a slot comprises/refers to AGC symbol for a second (candidate) occasion for transmitting PSCCH/PSSCH in the slot.

Preferably in certain embodiments, the TX UE transmits PSCCH and PSSCH via symbols in the first (candidate) occasion of PSCCH/PSSCH excluding the first and last symbol (or excluding AGC and the gap symbol of the first (candidate) occasion of PSCCH/PSSCH).

Preferably in certain embodiments, the TX UE transmits PSCCH and PSSCH via symbols in the second (candidate) occasion of PSCCH/PSSCH excluding the first and last symbol (or excluding AGC and the gap symbol of the second (candidate) occasion of PSCCH/PSSCH).

Preferably in certain embodiments, as shown in FIG. 7, the first (candidate) occasion of PSCCH/PSSCH and the second (candidate) occasion of PSCCH/PSSCH could be illustrated as one example.

Preferably in certain embodiments, the TX UE means/corresponds to the UE transmitting or would transmit PSCCH/PSSCH.

Preferably in certain embodiments, the RX UE means/corresponds to the UE receiving/monitoring or would receive/monitor PSCCH/PSSCH.

Preferably in certain embodiments, when the TX UE performs successful channel access for the first (candidate) occasion, the TX UE does not need to perform channel access for the second (candidate) occasion.

Preferably in certain embodiments, when the TX UE performs successful channel access for the first (candidate) occasion in a TTI, structure of the TTI is determined based on the first (candidate) occasion and/or there is no second (candidate) occasion (at least for same LBT band).

Preferably in certain embodiments, one carrier or one SL BWP comprises a number of LBT bands.

Preferably in certain embodiments, one LBT band corresponds to 20 MHz.

Preferably in certain embodiments, one sidelink resource pool comprises an integer number of LBT bands.

Preferably in certain embodiments, there may be more possible structure (in addition to FIG. 6).

Preferably in certain embodiments, the ending symbol of the first (candidate) occasion could be different than the ending symbol of the second (candidate) occasion.

Preferably in certain embodiments, the ending symbol of the first (candidate) occasion could be the preceding symbol of the second starting symbol, and/or the ending symbol of the first (candidate) occasion could be determined based on the second starting symbol.

Preferably in certain embodiments, the ending symbol of the first (candidate) occasion is determined based on at least the ending symbol of a COT.

Preferably in certain embodiments, the ending symbol of the first (candidate) occasion could be different than the preceding symbol of the second starting symbol when the first (candidate) occasion is the last TTI in a COT (i.e., the last TTI may comprise partially or fully symbols in the COT),

Preferably in certain embodiments, e.g., FIG. 6, the ending symbol of the first (candidate) occasion could be symbol #3 (which is preceding symbol of the second starting symbol #4).

Preferably in certain embodiments, the available symbol for SL CSI-RS in a first (candidate) occasion may depend on the ending symbol of the first (candidate) occasion.

Preferably in certain embodiments, there is a second specific field indicating a second specific value (in addition to the specific field and the specific value). Preferably in certain embodiments, the second specific value could be pre-configured or determined based on the second starting symbol. Preferably in certain embodiments, the second specific value could refer to (sl-LengthSymbols-1-#the second starting symbol). Preferably in certain embodiments, the second specific field and/or the second specific value is configured when the ending symbol position could be based on the second starting symbol in a TTI. Preferably in certain embodiments, the second specific field could indicate (information of) 0, or the second specific value. Preferably in certain embodiments, when the TX UE would use the first candidate occasion within a COT ending not in the last symbol available for sidelink or not in the last symbol before gap before PSFCH, the TX UE would set the second specific filed to be associated with the second specific value. For example, in FIG. 6, if the four slots are the last slot partially in a COT, the second specific value could be set to the second specific field in SCI and preferably the second specific value could be 9 (which is determined as 14-4-1). Preferably in certain embodiments, PSFCH overhead indication could set to 0.

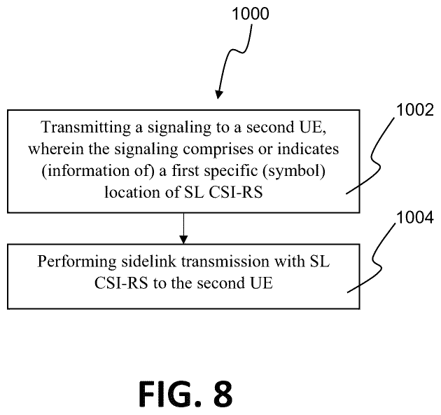

Referring to FIG. 8, with this and other concepts, systems, and methods of the present invention, a method 1000 for a first UE in a wireless communication system comprises transmitting a signaling to a second UE, wherein the signaling comprises or indicates (information of) a first specific (symbol) location of SL CSI-RS (step 1002) and performing sidelink transmission with SL CSI-RS to the second UE (step 1004).

Referring back to FIGS. 3 and 4, in one or more embodiments from the perspective of a first UE, the device 300 includes a program code 312 stored in memory 310 of the transmitter. The CPU 308 could execute program code 312 to: (i) transmit a signaling to a second UE, wherein the signaling comprises or indicates (information of) a first specific (symbol) location of SL CSI-RS; and (ii) perform sidelink transmission with SL CSI-RS to the second UE. Moreover, the CPU 308 can execute the program code 312 to perform all of the described actions, steps, and methods described above, below, or otherwise herein.

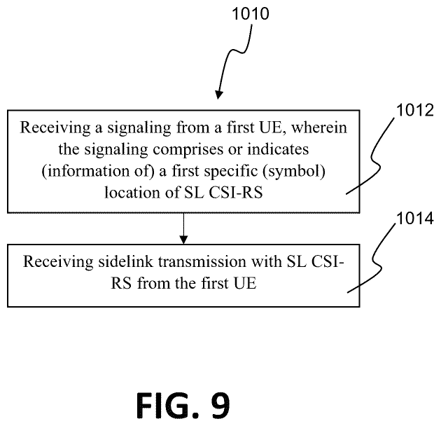

Referring to FIG. 9, with this and other concepts, systems, and methods of the present invention, a method 1010 for a second UE in a wireless communication system comprises receiving a signaling from a first UE, wherein the signaling comprises or indicates (information of) a first specific (symbol) location of SL CSI-RS (step 1012) and receiving sidelink transmission with SL CSI-RS from the first UE (step 1014).

Referring back to FIGS. 3 and 4, in one or more embodiments from the perspective of a second UE, the device 300 includes a program code 312 stored in memory 310 of the transmitter. The CPU 308 could execute program code 312 to: (i) receive a signaling from a first UE, wherein the signaling comprises or indicates (information of) a first specific (symbol) location of SL CSI-RS; and (ii) receive sidelink transmission with SL CSI-RS from the first UE. Moreover, the CPU 308 can execute the program code 312 to perform all of the described actions, steps, and methods described above, below, or otherwise herein.

Preferably in certain embodiments, the sidelink transmission with SL CSI-RS is performed in a TTI with more than one starting symbol positions.

Preferably in certain embodiments, the more than one starting symbol comprises a first starting symbol and a second starting symbol, wherein the second starting symbol is later than the first starting symbol.

Preferably in certain embodiments, based on channel access result and/or based on whether the first UE occupies a channel or initiates a COT at least comprises the first starting symbol or starting from the first starting symbol, the first UE could determine whether the sidelink transmission is performed starting from the first starting symbol or the second starting symbol in the TTI.

Preferably in certain embodiments, if the first UE initiates a COT for the first symbol in the TTI, the sidelink transmission is performed starting from the first starting symbol.

Preferably in certain embodiments, if (the first UE fails to initiate a COT for the first starting symbol) the first UE initiates a COT for the second starting symbol in the TTI, the sidelink transmission is performed starting from the second starting symbol.

Preferably in certain embodiments, the sidelink transmission comprises an AGC symbol in a very beginning symbol of the sidelink transmission, PSCCH, and/or PSSCH.

Preferably in certain embodiments, the SL CSI-RS is transmitted on symbols associated with the first specific symbol location and either the first or the second starting symbol.

Preferably in certain embodiments, the first specific symbol location is referenced or associated with either the first or the second starting symbol, based on the sidelink transmission starts from the first or the second starting symbol.

Preferably in certain embodiments, when the sidelink transmission starts from the first starting symbol in the TTI, SL CSI-RS is transmitted in the first specific symbol location which is referenced to symbol index 0.

Preferably in certain embodiments, when the sidelink transmission starts from the first starting symbol in the TTI, SL CSI-RS is transmitted in the first specific symbol location referenced to the first starting symbol.

Preferably in certain embodiments, when the sidelink transmission starts from the second starting symbol in the TTI, SL CSI-RS is transmitted in the first specific symbol location which is referenced to symbol index 0.

Preferably in certain embodiments, when the sidelink transmission starts from the second starting symbol in the TTI, SL CSI-RS is transmitted in the first specific symbol location which is referenced to the second starting symbol.

Preferably in certain embodiments, the second UE determines whether to receive SL CSI-RS based on where the second UE detects SCI for the sidelink transmission or where the second UE detects the sidelink transmission.

Preferably in certain embodiments, based on detecting SCI starting from the first starting symbol, the second UE receives SL CSI-RS in the first specific symbol location (which is referenced to the first starting symbol or symbol index 0).

Preferably in certain embodiments, based on detecting SCI starting from the second starting symbol, the second UE receives SL CSI-RS in the first specific symbol location (which is referenced to the second starting symbol or symbol index 0).

Preferably in certain embodiments, the signaling shall configure the first specific location being later than the second starting symbol.

Preferably in certain embodiments, the signaling shall configure the first specific location being later than the second starting symbol with an offset.

Preferably in certain embodiments, the offset in bullet 19 is associated with AGC symbol associated with the second starting symbol and PSCCH associated with the second starting symbol.

Preferably in certain embodiments, the signaling comprises or indicates (information of) a second specific symbol location.

Preferably in certain embodiments, the first specific symbol location is associated with the sidelink transmission starting from the first starting symbol and the second specific symbol location is associated with the sidelink transmission starting from the second starting symbol.

Preferably in certain embodiments, based on the sidelink transmission starts from the first or the second starting symbol, the SL CSI-RS is transmitted in the first or the second specific symbol location.

Preferably in certain embodiments, both the first and the second specific symbol location is referenced to symbol index 0.

Preferably in certain embodiments, possible/candidate value of the first and the second specific symbol location are the same.

Preferably in certain embodiments, available value of the first and the second specific symbol location are different.

Preferably in certain embodiments, possible/candidate value of the second specific symbol location is {the second starting symbol+3, . . . , 11, 12}.

Preferably in certain embodiments, possible/candidate value of the second specific symbol location is determined based on at least the second starting symbol location.

Preferably in certain embodiments, the signaling comprises or indicates (information of) offset (for determining a second specific symbol location).

Preferably in certain embodiments, for the sidelink transmission starting from the first starting symbol, SL CSI-RS is transmitted in symbol associated with the first specific symbol location.

Preferably in certain embodiments, for the sidelink transmission starting from the second starting symbol, SL CSI-RS is transmitted in symbol associated with the first specific symbol location with the offset in bullet 29.

Preferably in certain embodiments, if the first UE fails to perform the sidelink transmission starting from the first starting symbol (or the first UE performs the sidelink transmission starting from the second starting symbol), the first UE does not transmit SL CSI-RS associated with the sidelink transmission and/or the first UE is not allowed or does not trigger CSI request in SCI in the sidelink transmission.

Preferably in certain embodiments, the first UE is only allowed to trigger CSI request in SCI in sidelink transmission starting from the first starting symbol in a TTI.

Preferably in certain embodiments, the second UE does not expect to receive a SCI with triggered CSI request, wherein the SCI is transmitted in a sidelink transmission starting from the second starting symbol in a TTI.

Preferably in certain embodiments, the signaling is PC5 RRC signaling.

Preferably in certain embodiments, SL CSI-RS is transmitted in one symbol.

Preferably in certain embodiments, SL CSI-RS is associated with at most two ports.

Preferably in certain embodiments, the second starting symbol in a TTI does not exist when remaining number of symbols, starting from the second starting symbol to the end of symbol for sidelink in the TTI, is smaller than a threshold.

Preferably in certain embodiments, remaining number of symbols, starting from the second starting symbol to the end of symbol for sidelink in a TTI is counted by excluding symbol for AGC, PSFCH, and GAP.

Preferably in certain embodiments, the first UE communicates with the second UE, and/or the first UE initiates or generates or constructs a sidelink unicast link with the second UE.

Preferably in certain embodiments, the first UE performs sidelink transmission in a sidelink resource pool in unlicensed spectrum.

Preferably in certain embodiments, the first UE performs type-1/2/2-A/2-B/2-C channel access procedure for performing sidelink transmission.

Preferably in certain embodiments, the first UE performs type-1 channel access procedure to initiate a COT for sidelink transmission.

Preferably in certain embodiments, the first UE receives a SL grant, from a network node, for scheduling or activating one or more TTIs for sidelink transmission.

Preferably in certain embodiments, the first UE receives SL type-1 CG configuration for configuring one or more TTIs for sidelink transmission.

Preferably in certain embodiments, the first UE performs resource identification and/or selection for determining one or more TTIs for sidelink transmission.

Preferably in certain embodiments, the one or more TTIs configured/selected/identified/activated/scheduled for sidelink transmission are associated with the same TB or a different TB.

Preferably in certain embodiments, the one or more TTIs are in the same sidelink resource pool or in a different sidelink resource pool.

Preferably in certain embodiments, the one or more TTIs are in the same carrier/frequency band or in a different carrier/frequency band.

Preferably in certain embodiments, before performing sidelink transmission on the one or more TTIs, the first UE performs channel procedure at least for a first starting symbol of earliest TTI of the one or more TTIs.

Preferably in certain embodiments, one or more TTIs in the sidelink resource pool is (configured) with more than one starting symbol.

Preferably in certain embodiments, the more than one starting symbols are (configured) in a same TTI.

Any of the above and herein methods, alternatives, teachings, concepts, and embodiments may be combined or applied simultaneously.

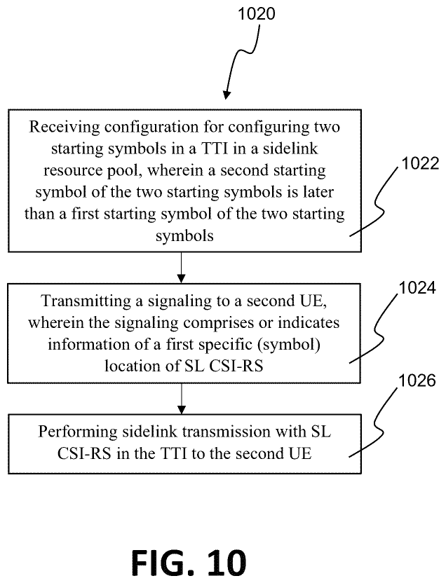

Referring to FIG. 10, with this and other concepts, systems, and methods of the present invention, a method 1020 for a first UE comprises receiving configuration for configuring two starting symbols in a TTI in a sidelink resource pool, wherein a second starting symbol of the two starting symbols is later than a first starting symbol of the two starting symbols (step 1022), transmitting a signaling to a second UE, wherein the signaling comprises or indicates information of a first specific (symbol) location of SL CSI-RS (step 1024), and performing sidelink transmission with SL CSI-RS in the TTI to the second UE (1026).

Preferably in certain embodiments, the signaling comprises or indicates a second specific location of SL CSI-RS, and/or the second specific location of SL CSI-RS is used when the sidelink transmission starts from the second starting symbol in the TTI; and/or when the sidelink transmission starts from the second starting symbol in the TTI, the first UE transmits the SL CSI-RS on a symbol based on the second specific location of SL CSI-RS, wherein the first UE sets a triggered SL CSI request in SCI; and/or when the sidelink transmission starts from the second starting symbol in the

TTI, the first UE transmits the SL CSI-RS on a second symbol associated with the second specific (symbol) location of SL CSI-RS.

Preferably in certain embodiments, the sidelink transmission starts from the first starting symbol in the TTI, the first UE transmits the SL CSI-RS on a symbol based on the first specific location of SL CSI-RS, wherein the first UE sets a triggered SL CSI request in SCI; or when the sidelink transmission starts from the first starting symbol in the TTI, the first UE transmits the SL CSI-RS on a first symbol associated with the first specific (symbol) location of SL CSI-RS.

Preferably in certain embodiments, an available or candidate value for a second specific location of SL CSI-RS is with an offset later than or referenced to the second starting symbol.

Preferably in certain embodiments, the offset corresponds to a number of symbols for PSCCH and/or a symbol for AGC; and/or the offset is a fixed value; and/or the offset is used for avoiding overlapping SL CSI-RS with symbols for AGC or PSCCH.

Preferably in certain embodiments, the sidelink transmission starts from the second starting symbol in the TTI, the first UE transmits the SL CSI-RS on a symbol based on the first specific (symbol) location of SL CSI-RS, wherein the first UE sets a triggered SL CSI request in SCI, and the first specific (symbol) location of SL CSI-RS is referenced to the second starting symbol; and/or when the sidelink transmission starts from the first starting symbol in the TTI, the first UE transmits the SL CSI-RS on a symbol based on the first specific (symbol) location of SL CSI-RS, wherein the first UE sets a triggered SL CSI request in SCI; and/or when the sidelink transmission starts from the first starting symbol in the TTI, the first UE transmits the SL CSI-RS on a first symbol associated with the first specific (symbol) location of SL CSI-RS; and/or when the sidelink transmission starts from the second starting symbol in the TTI, the first UE transmits the SL CSI-RS on a second symbol associated with a summation value of a value of the second starting symbol and a value of the first specific (symbol) location of SL CSI-RS.

Preferably in certain embodiments, the sidelink resource pool is in a carrier or a cell in shared spectrum or unlicensed spectrum.

Preferably in certain embodiments, based on a channel access result and/or based on whether the first UE occupies a channel or initiates a COT at least comprising the first starting symbol or starting from the first starting symbol, the first UE determines whether the sidelink transmission is performed starting from the first starting symbol or the second starting symbol in the TTI.

Preferably in certain embodiments, when the first UE initiates or occupies a COT for or comprising the first starting symbol in the TTI, the sidelink transmission is performed starting from the first starting symbol; and/or when (the first UE fails to initiate a COT for/comprising the first starting symbol and) the first UE initiates or occupies a COT for the second starting symbol in the TTI, the sidelink transmission is performed starting from the second starting symbol.

Preferably in certain embodiments, the signaling is PC5-RRC signaling.

Referring back to FIGS. 3 and 4, in one or more embodiments from the perspective of a first UE, the device 300 includes a program code 312 stored in memory 310 of the transmitter. The CPU 308 could execute program code 312 to: (i) receive configuration for configuring two starting symbols in a TTI in the sidelink resource pool, wherein a second starting symbol of the two starting symbols is later than a first starting symbol of the two starting symbols; (ii) transmit a signaling to a second UE, wherein the signaling comprises or indicates information of a first specific (symbol) location of SL CSI-RS; and (iii) perform sidelink transmission with SL CSI-RS in the TTI to the second UE. Moreover, the CPU 308 can execute the program code 312 to perform all of the described actions, steps, and methods described above, below, or otherwise herein.

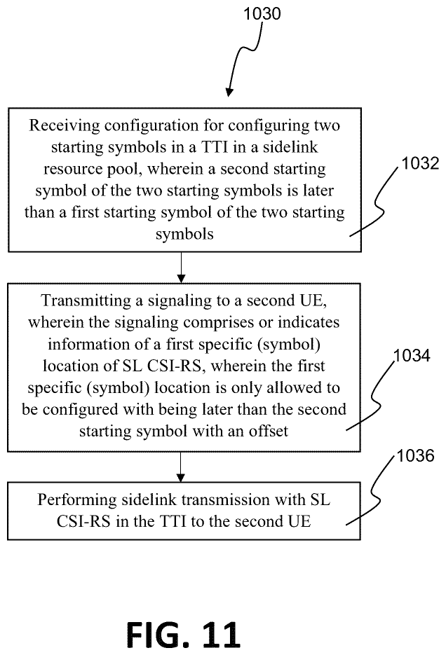

Referring to FIG. 11, with this and other concepts, systems, and methods of the present invention, a method 1030 for a first UE comprises receiving configuration for configuring two starting symbols in a TTI in a sidelink resource pool, wherein a second starting symbol of the two starting symbols is later than a first starting symbol of the two starting symbols (step 1032), transmitting a signaling to a second UE, wherein the signaling comprises or indicates information of a first specific (symbol) location of SL CSI-RS, wherein the first specific (symbol) location is only allowed to be configured with being later than the second starting symbol with an offset (step 1034), and performing sidelink transmission with SL CSI-RS in the TTI to the second UE (step 1036).

Preferably in certain embodiments, the first specific (symbol) location is not allowed to be configured with being earlier than the second starting symbol with an offset.

Preferably in certain embodiments, the offset corresponds to a number of symbols for PSCCH) and/or a symbol for AGC; and/or the offset is a fixed value; and/or the offset is used for avoiding overlapping SL CSI-RS with symbols for AGC or PSCCH.

Preferably in certain embodiments, the SL CSI-RS is transmitted on the first specific (symbol) location in the TTI.

Preferably in certain embodiments, no matter whether the first UE occupies a channel or initiates a COT from the first starting symbol or the second starting symbol, the first UE performs the sidelink transmission with the SL CSI-RS on a first symbol associated with the first specific (symbol) location of SL CSI-RS in the TTI, and wherein the first UE sets a triggered SL CSI request in SCI.

Preferably in certain embodiments, the signaling is PC5-RRC signaling.

Referring back to FIGS. 3 and 4, in one or more embodiments from the perspective of a first UE, the device 300 includes a program code 312 stored in memory 310 of the transmitter. The CPU 308 could execute program code 312 to: (i) receive configuration for configuring two starting symbols in a TTI in the sidelink resource pool, wherein a second starting symbol of the two starting symbols is later than a first starting symbol of the two starting symbols; (ii) transmit a signaling to a second UE, wherein the signaling comprises or indicates information of a first specific (symbol) location of SL CSI-RS, wherein the first specific (symbol) location is only allowed to be configured with being later than the second starting symbol with an offset; and (iii) perform sidelink transmission with SL CSI-RS in the TTI to the second UE. Moreover, the CPU 308 can execute the program code 312 to perform all of the described actions, steps, and methods described above, below, or otherwise herein.

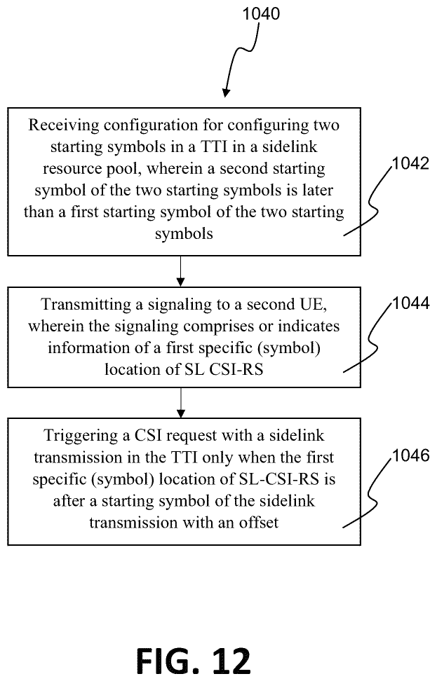

Referring to FIG. 12, with this and other concepts, systems, and methods of the present invention, a method 1040 for a first UE comprises receiving configuration for configuring two starting symbols in a TTI in a sidelink resource pool, wherein a second starting symbol of the two starting symbols is later than a first starting symbol of the two starting symbols (step 1042), transmitting a signaling to a second UE, wherein the signaling comprises or indicates information of a first specific (symbol) location of SL CSI-RS (step 1044), and triggering an CSI request with a sidelink transmission in the TTI only when the first specific (symbol) location of SL-CSI-RS is after a starting symbol of the sidelink transmission with an offset (step 1046).

Preferably in certain embodiments, the first specific (symbol) location of SL CSI-RS is not after the second starting symbol with the offset; and/or the first specific (symbol) location of SL CSI-RS is earlier than the second starting symbol; and/or the first specific (symbol) location of SL CSI-RS is within the offset after the second starting symbol.

Preferably in certain embodiments, when the sidelink transmission starts from the second starting symbol in the TTI, the first UE is not allowed to transmit the SL CSI-RS on a symbol based on the first specific (symbol) location of SL CSI-RS, and/or the first UE is not allowed to set a triggered SL CSI request in SCI.

Preferably in certain embodiments, when the sidelink transmission starts from the first starting symbol in the TTI, the first UE transmits the SL CSI-RS on a symbol based on the first specific (symbol) location of SL CSI-RS, and wherein the first UE sets a triggered SL CSI request in SCI.

Preferably in certain embodiments, the offset corresponds to a number of symbols for PSCCH and/or a symbol for AGC; and/or the offset is a fixed value; and/or the offset is used for avoiding overlapping SL CSI-RS with symbols for AGC or PSCCH.

Preferably in certain embodiments, the sidelink transmission starts from the second starting symbol in the TTI and when the first specific (symbol) location of SL-CSI-RS is after the second starting symbol of the sidelink transmission with the offset, the first UE is allowed to transmit the SL CSI-RS on a first symbol associated with the first specific (symbol) location of SL CSI-RS and/or the first UE is allowed to set a triggered SL CSI request in SCI; and/or when the sidelink transmission starts from the second starting symbol in the TTI and when the first specific (symbol) location of SL-CSI-RS is before the second starting symbol of the sidelink transmission with the offset, the first UE is not allowed to transmit the SL CSI-RS on the first symbol associated with the first specific (symbol) location of SL CSI-RS and/or the first UE is not allowed to set a triggered SL CSI request in SCI.

Preferably in certain embodiments, the signaling is PC5-RRC signaling.

Referring back to FIGS. 3 and 4, in one or more embodiments from the perspective of a first UE, the device 300 includes a program code 312 stored in memory 310 of the transmitter. The CPU 308 could execute program code 312 to: (i) receive configuration for configuring two starting symbols in a TTI in the sidelink resource pool, wherein a second starting symbol of the two starting symbols is later than a first starting symbol of the two starting symbols; (ii) transmit a signaling to a second UE, wherein the signaling comprises or indicates information of a first specific (symbol) location of SL CSI-RS; and (iii) trigger a CSI request with a sidelink transmission in the TTI only when the first specific (symbol) location of SL-CSI-RS is after a starting symbol of the sidelink transmission with an offset. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory,

EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a first User Equipment (UE) performing sidelink transmission in a sidelink resource pool, comprising:
receiving configuration for configuring two starting symbols in a Transmission Time Interval (TTI) in the sidelink resource pool, wherein a second starting symbol of the two starting symbols is later than a first starting symbol of the two starting symbols;
transmitting a signaling to a second UE, wherein the signaling comprises or indicates information of a first specific location of Sidelink (SL) Channel State Information Reference Signal (CSI-RS); and
performing sidelink transmission with SL CSI-RS in the TTI to the second UE.

2. The method of claim 1, wherein the signaling comprises or indicates a second specific location of SL CSI-RS, and/or the second specific location of SL CSI-RS is used when the sidelink transmission starts from the second starting symbol in the TTI; and/or
when the sidelink transmission starts from the second starting symbol in the TTI, the first UE transmits the SL CSI-RS on a symbol based on the second specific location of SL CSI-RS, wherein the first UE sets a triggered SL CSI request in Sidelink Control Information (SCI); and/or
when the sidelink transmission starts from the second starting symbol in the TTI, the first UE transmits the SL CSI-RS on a second symbol associated with the second specific location of SL CSI-RS.

3. The method of claim 1, when the sidelink transmission starts from the first starting symbol in the TTI, the first UE transmits the SL CSI-RS on a symbol based on the first specific location of SL CSI-RS, wherein the first UE sets a triggered SL CSI request in SCI; or
when the sidelink transmission starts from the first starting symbol in the TTI, the first UE transmits the SL CSI-RS on a first symbol associated with the first specific location of SL CSI-RS.

4. The method of claim 1, wherein an available or candidate value for a second specific location of SL CSI-RS is with an offset later than or referenced to the second starting symbol.

5. The method of claim 4, wherein the offset corresponds to a number of symbols for Physical Sidelink Control Channel (PSCCH) and/or a symbol for Automatic Gain Control (AGC); and/or
the offset is a fixed value; and/or
the offset is used for avoiding overlapping SL CSI-RS with symbols for AGC or PSCCH.

6. The method of claim 1, when the sidelink transmission starts from the second starting symbol in the TTI, the first UE transmits the SL CSI-RS on a symbol based on the first specific location of SL CSI-RS, wherein the first UE sets a triggered SL CSI request in SCI, and the first specific location of SL CSI-RS is referenced to the second starting symbol; and/or
when the sidelink transmission starts from the first starting symbol in the TTI, the first UE transmits the SL CSI-RS on a symbol based on the first specific location of SL CSI-RS, wherein the first UE sets a triggered SL CSI request in SCI; and/or
when the sidelink transmission starts from the first starting symbol in the TTI, the first UE transmits the SL CSI-RS on a first symbol associated with the first specific location of SL CSI-RS; and/or
when the sidelink transmission starts from the second starting symbol in the TTI, the first UE transmits the SL CSI-RS on a second symbol associated with a summation value of a value of the second starting symbol and a value of the first specific location of SL CSI-RS.

7. The method of claim 1, wherein the sidelink resource pool is in a carrier or a cell in shared spectrum or unlicensed spectrum.

8. The method of claim 1, wherein based on a channel access result and/or based on whether the first UE occupies a channel at least comprising the first starting symbol or starting from the first starting symbol or initiates a Channel Occupancy Time (COT) at least comprising the first starting symbol or starting from the first starting symbol, the first UE determines whether the sidelink transmission is performed starting from the first starting symbol or the second starting symbol in the TTI.

9. The method of claim 1, wherein when the first UE initiates or occupies a COT for the first starting symbol in the TTI, the sidelink transmission is performed starting from the first starting symbol; and/or
when the first UE initiates or occupies a COT for the second starting symbol in the TTI, the sidelink transmission is performed starting from the second starting symbol.

10. A method of a first User Equipment (UE) performing sidelink transmission in a sidelink resource pool, comprising:
receiving configuration for configuring two starting symbols in a Transmission Time Interval (TTI) in the sidelink resource pool, wherein a second starting symbol of the two starting symbols is later than a first starting symbol of the two starting symbols;
transmitting a signaling to a second UE, wherein the signaling comprises or indicates information of a first specific location of Sidelink (SL) Channel State Information Reference Signal (CSI-RS), wherein the first specific location is only allowed to be configured with being later than the second starting symbol with an offset; and
performing sidelink transmission with SL CSI-RS in the TTI to the second UE.

11. The method of claim 10, wherein the first specific location is not allowed to be configured with being earlier than the second starting symbol with an offset.

12. The method of claim 10, wherein the offset corresponds to a number of symbols for Physical Sidelink Control Channel (PSCCH) and/or a symbol for Automatic Gain Control (AGC); and/or
the offset is a fixed value; and/or
the offset is used for avoiding overlapping SL CSI-RS with symbols for AGC or PSCCH.

13. The method of claim 10, wherein the SL CSI-RS is transmitted on the first specific location in the TTI.

14. The method of claim 10, wherein no matter whether the first UE occupies a channel or initiates a Channel Occupancy Time (COT) from the first starting symbol or the second starting symbol, the first UE performs the sidelink transmission with the SL CSI-RS on a first symbol associated with the first specific location of SL CSI-RS in the TTI, and wherein the first UE sets a triggered SL CSI request in SCI.

15. A method of a first User Equipment (UE) performing sidelink transmission in a sidelink resource pool, comprising:
receiving configuration for configuring two starting symbols in a Transmission Time Interval (TTI) in the sidelink resource pool, wherein a second starting symbol of the two starting symbols is later than a first starting symbol of the two starting symbols;
transmitting a signaling to a second UE, wherein the signaling comprises or indicates information of a first specific location of Sidelink (SL) Channel State Information Reference Signal (CSI-RS); and
triggering a CSI request with a sidelink transmission in the TTI only when the first specific location of SL-CSI-RS is after a starting symbol of the sidelink transmission with an offset.

16. The method of claim 15, wherein the first specific location of SL CSI-RS is not after the second starting symbol with the offset; and/or
the first specific location of SL CSI-RS is earlier than the second starting symbol; and/or
the first specific location of SL CSI-RS is within the offset after the second starting symbol.

17. The method of claim 16, wherein when the sidelink transmission starts from the second starting symbol in the TTI, the first UE is not allowed to transmit the SL CSI-RS on a symbol based on the first specific location of SL CSI-RS, and/or the first UE is not allowed to set a triggered SL CSI request in Sidelink Control Information (SCI).

18. The method of claim 15, wherein when the sidelink transmission starts from the first starting symbol in the TTI, the first UE transmits the SL CSI-RS on a symbol based on the first specific location of SL CSI-RS, and wherein the first UE sets a triggered SL CSI request in SCI.

19. The method of claim 15, wherein the offset corresponds to a number of symbols for Physical Sidelink Control Channel (PSCCH) and/or a symbol for Automatic Gain Control (AGC); and/or
the offset is a fixed value; and/or
the offset is used for avoiding overlapping SL CSI-RS with symbols for AGC or PSCCH.

20. The method of claim 15, wherein when the sidelink transmission starts from the second starting symbol in the TTI and when the first specific location of SL-CSI-RS is after the second starting symbol of the sidelink transmission with the offset, the first UE is allowed to transmit the SL CSI-RS on a first symbol associated with the first specific location of SL CSI-RS and/or the first UE is allowed to set a triggered SL CSI request in SCI; and/or
when the sidelink transmission starts from the second starting symbol in the TTI and when the first specific location of SL-CSI-RS is before the second starting symbol of the sidelink transmission with the offset, the first UE is not allowed to transmit the SL CSI-RS on the first symbol associated with the first specific location of SL CSI-RS and/or the first UE is not allowed to set a triggered SL CSI request in SCI.
